(19) United States
(12) Patent Application Publication
(10) Pub. No.: US 2015/0028789 A1
(43) Pub. Date: Jan. 29, 2015

(54) Motor Drive Control and Operating Method Therefor

(71) Applicant: Renesas Electronics Corporation, Kawasaki-shi (JP)

(72) Inventor: Ryuhei Uchida, Kanagawa (JP)

(21) Appl. No.: 14/337,400

(22) Filed: Jul. 22, 2014

(30) Foreign Application Priority Data
Jul. 23, 2013 (JP) 2013-152436

(51) Int. Cl. G05B 6/02; H02P 25/02

(52) U.S. Cl. CPC G05B 6/02; H02P 25/028
USPC 318/619

(57) ABSTRACT

A digital control section generates a digital drive voltage command signal in response to a digital drive current command value and to a drive current digital sensing signal. A digital-to-analog converter generates an analog drive voltage command signal from the digital drive voltage command signal. In response to the analog drive voltage command signal, a driver output section drives a motor and a sensing resistor. If the digital drive current command value is between a positive threshold voltage and a negative threshold voltage, the computation section generates an internal control signal that is in a first state “1”, and exercises control to place the gain of the drive current sensing amplifier in a first state “H”. If not, the computation section exercises control to place the gain of the drive current sensing amplifier in a second state “L”, namely, in a low state.

### CROSS-REFERENCE TO RELATED APPLICATIONS

The disclosure of Japanese Patent Application No. 2013-152436 filed on Jul. 23, 2013 including the specification, drawings, and abstract is incorporated herein by reference in its entirety.

### BACKGROUND

The present invention relates to a motor drive control device for driving, for instance, a voice coil motor (VCM) that moves the magnetic head of a hard disk drive (HDD). The present invention also relates to an operating method for the motor drive control device. More specifically, the present invention relates to a technology effective for reducing the burden on a design engineer of a hard disk drive and the like.

For a hard disk drive (HDD), a load/unload method is employed so that a magnetic head is retracted to a ramp mechanism and parked when no data is read or written. The ramp mechanism is disposed outside of the outer circumference of a magnetic disk. A read/write operation is initiated by performing a loading operation in compliance with a command from a host to move the magnetic head from the retracted position of the ramp mechanism to the surface of the magnetic disk. Upon completion of the read/write operation, an unloading operation is performed in compliance with a command from the host to move the magnetic head from the surface of the magnetic disk to the retracted position of the ramp mechanism.

Further, a spindle motor in the hard disk drive (HDD) rotates the magnetic disk at high speed. The magnetic head is then positioned close to the surface of the rotating magnetic disk for a read/write operation. A voice coil motor (VCM) then moves the magnetic head in the radial direction of the magnetic disk to read information from or write information to the magnetic disk.

Japanese Unexamined Patent Publications No. 2005-304095 and 2005-304096 describe a voice coil motor drive circuit of a hard disk drive (HDD) that provides PWM drive to let the magnetic head perform a seek operation and a tracking operation for the purpose of solving problems, for instance, of design burden and circuit scale concerning related-art methods of PWM drive for the seek operation and linear drive for the tracking operation. As is well known, the seek operation is performed to move the magnetic head to a desired storage track, whereas the tracking operation is performed to move the magnetic head so as to follow a desired storage track for a read/write operation. Further, Japanese Unexamined Patent Publications No. 2005-304095 and 2005-304096 describe a control circuit that is formed of a digital circuit to provide feedback control over a coil drive current for a voice coil motor (VCM) of the hard disk drive (HDD).

### SUMMARY

Before the disclosure of the present invention, inventors of the present invention were engaged in the development of a voice coil motor driver that is a semiconductor integrated circuit for driving the voice coil motor (VCM), which moves the magnetic head in the hard disk drive (HDD).

FIG. 8 is a diagram illustrating the configuration of the voice coil motor driver, which is a semiconductor integrated circuit IC studied by the inventors before the disclosure of the present invention.

The semiconductor integrated circuit IC depicted in FIG. 8 is a voice coil motor driver that drives a voice coil motor (VCM) for moving the magnetic head. More specifically, it is a high-density semiconductor integrated circuit called a combo driver, which is an integrated circuit having a spindle motor driver and a voice coil motor driver. The spindle motor driver drives a spindle motor that rapidly rotates the magnetic disk. The voice coil motor driver drives the voice coil motor.

A semiconductor chip of the semiconductor integrated circuit IC depicted in FIG. 8 is an integrated chip that includes a digital difference generation/phase compensation control section 100, a digital-to-analog converter 101, a driver output section 102, a drive current sensing amplifier 103, an analog-to-digital converter 104, a decimation filter 105, an offset calibration section 106, and a serial input/output interface 107.

First and second VCM driver output terminals VCMP, VCMN of the driver output section 102 in the semiconductor integrated circuit IC depicted in FIG. 8 are coupled to a voice coil motor (VCM) having a coil L and a parasitic resistor RL and to a current sensing resistor Rs.

### <<Detailed Configuration of Semiconductor Integrated Circuit>>

The configuration of the semiconductor integrated circuit IC depicted in FIG. 8 will now be described in detail.

### <<Serial Input/Output Interface>>

A digital drive current command value VCMCRNT, integration gain information IGAIN, proportional gain information PGAIN, a PWM operation enable signal PWMENA, a digital control signal VCMFS, and a calibration enable signal CALENA are supplied to the serial input/output interface 107 from, for example, a microcomputer external to the semiconductor integrated circuit IC. The digital control signal VCMFS, in particular, controls the full-scale magnitude of a voice coil motor (VCM) coil drive current Ivcm.

The digital drive current command value VCMCRNT, the integration gain information IGAIN, and the proportional gain information PGAIN are supplied from the serial input/output interface 107 to the digital difference generation/phase compensation control section 100. The PWM operation enable signal PWMENA is supplied from the serial input/output interface 107 to the driver output section 102. The digital control signal VCMFS is supplied from the serial input/output interface 107 to the drive current sensing amplifier 103. The calibration enable signal CALENA is supplied from the serial input/output interface 107 to the offset calibration section 106.

### <<Digital Difference Generation/Phase Compensation Control Section>>

The digital difference generation/phase compensation control section 100 includes a digital amplifier 1001 formed of a digital multiplier, a digital subtractor 1002, two digital multipliers 1003, 1004, a digital integrator 1005, and a digital adder 1006.

The digital difference generation/phase compensation control section 100 generates current difference information IERR, which represents the difference between command information about the digital drive current command value VCMCRNT supplied from a controller and feedback information about a drive current digital sensing signal DIVCM generated from voice coil motor drive current information of the drive current sensing amplifier 103, and generates drive voltage command signals DDRV, ADRV, which are supplied to the input of the driver output section 102.

The digital amplifier 1001, which is formed of a digital multiplier, digitally amplifies the digital drive current command value VCMCRNT, which is supplied from the external microcomputer or other controller through the serial input/output interface 107. The digital drive current command value VCMCRNT, which is digitally amplified by the digital amplifier 1001, is supplied to one input terminal of the digital subtractor 1002, and the drive current digital sensing signal DIVCM, which is generated from a digital amplifier 1063 of the offset calibration section 106, is supplied to the other input terminal of the digital subtractor 1002. As a result, digital difference drive current information IERR, which is generated from the output terminal of the digital subtractor 1002, is supplied to one input terminal of the digital multiplier 1003 and to one input terminal of the digital multiplier 1004.

The integration gain information IGAIN and the proportional gain information PGAIN are stored beforehand in two control registers of the serial input/output interface 107 by the external microcomputer or other controller. Therefore, the integration gain information IGAIN and the proportional gain information PGAIN are supplied from the serial input/output interface to the other input terminal of the digital multiplier 1003 and to the other input terminal of the digital multiplier 1004, respectively. As a result, the digital multiplier 1003 multiplies the digital difference drive current information IERR of the digital subtractor 1002 by the integration gain information IGAIN of the serial input/output interface 107 and supplies the result of multiplication to the input terminal of the digital integrator 1005. Further, the digital multiplier 1004 multiplies the digital difference drive current information IERR of the digital subtractor 1002 by the proportional gain information PGAIN of the serial input/output interface 107 and supplies the result of multiplication to one input terminal of the digital adder 1006. Furthermore, digital difference drive current integration information is supplied from the output terminal of the digital integrator 1005 to the other input terminal of the digital adder 1006, and digital difference drive current proportional information is supplied from the output terminal of the digital multiplier 1004 to one input terminal of the digital adder 1006. Therefore, digital difference dive current proportional integration information (proportional integration information), which is generated from the output terminal of the digital adder 1006 of the digital difference generation/phase compensation control section 100 as a digital drive voltage command signal DDRV, is supplied to the input terminal of the digital-to-analog converter 101.

### <<Digital-to-Analog Converter>>

In the semiconductor integrated circuit IC depicted in FIG. 8, the digital drive voltage command signal DDRV, which is generated from the output terminal of the digital adder 1006 of the digital difference generation/phase compensation control section 100, is converted to an analog drive voltage command signal ADRV by the digital-to-analog converter 101 and supplied to the input terminal of the driver output section 102.

A ΣΔ digital-to-analog converter capable of performing high-resolution digital-to-analog conversion at high speed is employed as the digital-to-analog converter 101. As the ΣΔ digital-to-analog converter is mostly formed of a digital circuit, low power consumption and high speed can be achieved by an ultra-small semiconductor manufacturing process for the semiconductor integrated circuit IC. Further, in the ΣΔ digital-to-analog converter, the difference between a converted output signal and an input signal is generated by ΣΔ modulation. The generated difference is then integrated. The resulting integrated value is eventually minimized by performing a feedback process. As a result, quantization noise included in the output of a comparator in the ΣΔ digital-to-analog converter is shifted to a high frequency region due to the so-called noise shaping effect. This makes it possible to achieve a high signal-to-noise ratio.

### <<Driver Output Section>>

In the semiconductor integrated circuit IC depicted in FIG. 8, the driver output section 102 drives the current sensing resistor Rs and the voice coil motor (VCM), which are coupled between the first VCM driver output terminal VCMP and the second VCM driver output terminal VCMN, in response to the analog drive voltage command signal ADRV from the digital-to-analog converter 101. The voice coil motor (VCM) includes the coil L and the parasitic resistor RL, which are coupled in series.

As depicted in FIG. 1, the driver output section 102 includes a pre-driver 1021, a feedback capacitor 1022, a feedback resistor 1023, a PWM modulator 1024, a first VCM driver output amplifier 1025, a second VCM driver output amplifier 1026, and a feedback amplifier 1027.

The analog drive voltage command signal ADRV from the digital-to-analog converter 101 is supplied to a non-inverting input terminal+ of the pre-driver 1021, and a feedback output signal of the feedback amplifier 1027 is supplied to an inverting input terminal− of the pre-driver 1021 through the feedback capacitor 1022 and the feedback resistor 1023. The output terminal of the pre-driver 1021 is coupled to the input terminal of the PWM modulator 1024. The output terminal of the PWM modulator 1024 is coupled to a first input terminal In1 of the first VCM driver output amplifier 1025 and to a first input terminal In1 of the second VCM driver output amplifier 1026. The output signal of the pre-driver 1021 is supplied to a second input terminal In2 of the first VCM driver output amplifier 1025 and to a second input terminal In2 of the second VCM driver output amplifier 1026.

The output terminal of the first VCM driver output amplifier 1025 is coupled to the first VCM driver output terminal VCMP and to an inverting input terminal− of the feedback amplifier 1027. The output terminal of the second VCM driver output amplifier 1026 is coupled to the second VCM driver output terminal VCMN and to a non-inverting input terminal+ of the feedback amplifier 1027.

Further, the PWM operation enable signal PWMENA is supplied from the external microcomputer or other controller to the first VCM driver output amplifier 1025 and the second VCM driver output amplifier 1026 through the serial input/output interface 107.

When a high-level PWM operation enable signal PWMENA is supplied, the first VCM driver output amplifier 1025 and the second VCM driver output amplifier 1026 respond to a triangular wave PWM carrier signal supplied from the PWM modulator 1024 to the first input terminal In1 and to a pre-driver output signal supplied from the pre-driver 1021 to the second input terminal In2. Therefore, the first VCM driver output amplifier 1025 and the second VCM driver output amplifier 1026 generate a drive pulse output signal having a pulse width proportional to the voltage level of the pre-driver output signal of the pre-driver 1021. In such an instance, a small bias voltage is supplied to amplifying transistors of the first VCM driver output amplifier 1025 and the second VCM driver output amplifier 1026 in response to the high-level PWM operation enable signal PWMENA. Hence, the amplifying transistors can perform a class D amplifier operation to reduce their power consumption.

Drive pulse output signals having opposite phases are generated from the first VCM driver output amplifier 1025 and the second VCM driver output amplifier 1026. The drive pulse output signals having opposite phases drive both terminals of the voice coil motor (VCM). A pulse drive mode based on PWM control in which a drive pulse width varies is suitable, for instance, for a seek operation and other operations in which the magnetic head is driven to move to a large extent.

When a low-level PWM operation enable signal PWMENA is supplied, the first VCM driver output amplifier 1025 and the second VCM driver output amplifier 1026 enter a linear drive mode, which generates an amplifier output signal proportional to the voltage level of the pre-driver output signal of the pre-driver 1021. In this case, therefore, the first VCM driver output amplifier 1025 and the second VCM driver output amplifier 1026 do not respond to the triangular wave PWM carrier signal supplied from the PWM modulator 1024 to the first input terminal In1. In such an instance, a significant bias voltage is supplied to the amplifying transistors of the first VCM driver output amplifier 1025 and the second VCM driver output amplifier 1026 in response to the low-level PWM operation enable signal PWMENA. Hence, the amplifying transistors can perform a class AB amplifier operation to reduce the distortion in a signal amplified by them.

Linear amplifier output signals having opposite phases are generated from the first VCM driver output amplifier 1025 and the second VCM driver output amplifier 1026. The linear amplifier output signals having opposite phases drive both terminals of the voice coil motor (VCM). The linear drive mode based on analog control in which an amplified amplitude varies is suitable, for instance, for a tracking operation and other operations in which the magnetic head is driven to move to a small extent.

The pre-driver 1021, feedback capacitor 1022, feedback resistor 1023, and feedback amplifier 1027 included in the driver output section 102 depicted in FIG. 1 function as a negative feedback loop that enhances the amplification accuracy of the driver output section 102. The negative feedback loop also functions when the first VCM driver output amplifier 1025 and the second VCM driver output amplifier 1026 operate in either the pulse drive mode or the linear drive mode. In other words, the feedback amplifier 1027 senses an inter-terminal amplified voltage between the output terminal of the first VCM driver output amplifier 1025 and the output terminal of the second VCM driver output amplifier 1026, and supplies the sensed inter-terminal amplified voltage to the inverting input terminal− of the pre-driver 1021. As the analog drive voltage command signal ADRV from the digital-to-analog converter 101 is supplied to the non-inverting input terminal+ of the pre-driver 1021, the negative feedback loop functions in such a manner that the voltage information about the inverting input terminal− of the pre-driver 1021 agrees with the voltage information about the non-inverting input terminal+ of the pre-driver 1021. Consequently, the analog drive voltage command signal ADRV at the non-inverting input terminal+ of the pre-driver agrees with the amplified voltage between the output terminals of the first and second VCM driver output amplifiers 1025, 1026, which is delivered to the inverting input terminal− of the pre-driver 1021. The feedback capacitor 1022 and the feedback resistor 1023 not only function as a phase compensation circuit for improving the stability of the negative feedback loop, but also function as a filter for smoothing a pulse waveform signal output from the feedback amplifier 1027 during a PWM operation.

### <<Drive Current Sensing Amplifier>>

In the semiconductor integrated circuit IC depicted in FIG. 8, the inter-terminal voltage of the current sensing resistor Rs is supplied to a differential input terminal of the drive current sensing amplifier 103 through two current sensing terminals RSINP, RSINN. One current sensing terminal RSINP is coupled to a non-inverting input terminal+ of a differential amplifier 1031 in the drive current sensing amplifier 103 through a resistor 1032. A reference voltage V_{REF} is supplied to this non-inverting input terminal+ through a resistor 1033. The other current sensing terminal RSINN is coupled to an inverting input terminal− of the differential amplifier 1031 in the drive current sensing amplifier 103 through a resistor 1034. This inverting input terminal− is coupled to the output terminal of the differential amplifier 1031 through a resistor 1035.

Hence, the drive current sensing amplifier 103 senses the current value of a coil drive current Ivcm that flows in the current sensing resistor Rs coupled in series to the voice coil motor (VCM). A drive current analog sensing signal AIVCM generated from the output terminal of the drive current sensing amplifier 103 is converted to the drive current digital sensing signal DIVCM by the analog-to-digital converter 104, the decimation filter 105, and the offset calibration section 106. In other words, the drive current information about the voice coil motor (VCM) is used as feedback information about the drive current digital sensing signal DIVCM, which is to be delivered to the digital difference generation/phase compensation control section 100.

An amplifier gain of the drive current sensing amplifier 103 can be set by the digital control signal VCMFS, which is supplied from the external microcomputer or other controller through the serial input/output interface 107.

### <<Analog-to-Digital Converter>>

In the semiconductor integrated circuit IC depicted in FIG. 8, an analog amplifier output signal from the output terminal of the drive current sensing amplifier 103 is converted to a digital current sensing signal by the analog-to-digital converter 104 and supplied to the input terminal of the decimation filter 105.

An oversampling ΣΔ analog-to-digital converter, which has a small circuit scale and is capable of reducing folding noise and quantization noise, is used as the analog-to-digital converter 104. This oversampling ΣΔ analog-to-digital converter can be formed of an analog subtractor, an analog integrator, a comparator, a delay circuit, and a 1-bit local digital-to-analog converter. Therefore, the circuit scale can be reduced. Further, the oversampling ΣΔ analog-to-digital converter also performs difference generation, difference integration, and integrated value feedback processing. Therefore, a high signal-to-noise ratio can be achieved due to the noise shaping effect.

### <<Decimation Filter>>

The decimation filter 105 in the semiconductor integrated circuit IC depicted in FIG. 8 performs a decimation process so that a sampling rate raised by the above-mentioned oversampling ΣΔ analog-to-digital converter 104 is lowered to an appropriate sampling rate. The decimation filter 105 also functions as a low-pass filter that suppresses the quantization noise in a high-frequency region, which is increased by an amount by which the quantization noise in a low-frequency region is reduced due to the noise shaping effect produced by the oversampling ΣΔ analog-to-digital converter 104. Hence, although the decimation filter 105 is formed of a digital filter, it includes a low-pass filter and a decimation circuit.

### <<Offset Calibration Section>>

Before feedback control is exercised by the digital difference generation/phase compensation control section 100, the offset calibration section 106 in the semiconductor integrated circuit IC depicted in FIG. 8 performs a calibration operation to reduce the error in the drive current sensing amplifier 103, the analog-to-digital converter 104, and the decimation filter 105. To permit such an operation to be performed, control is exercised so that the current value of the coil drive current Ivcm of the voice coil motor (VCM) is zero, and the inter-terminal voltage of the current sensing resistor Rs is supplied to the differential input terminal of the drive current sensing amplifier 103 through the two current sensing terminals RSINP, RSINN. The whole error information obtained in the resulting state, including the information about the error in the drive current sensing amplifier 103, the error in the analog-to-digital converter 104, and the error in the decimation filter 105, is stored in a calibration register 1061 in the offset calibration section 106. In response to the calibration enable signal CALENA, the above-mentioned whole error information is stored from the decimation filter 105 into the calibration register 1061 in the offset calibration section 106 and kept in storage.

In a subsequent drive current sensing operation, the error information stored in the calibration register 1061 in the offset calibration section 106 is supplied to a digital subtractor 1062. The digital subtractor 1062 then subtracts the error information from a whole set of normally sensed information. The whole set of normally sensed information includes a normally output signal of the drive current sensing amplifier 103, a normally converted signal of the analog-to-digital converter 104, and a normally output signal of the decimation filter 105. A subtractor output signal of the digital subtractor 1062 in the offset calibration section 106 is digitally amplified by the digital amplifier 1063 formed of a digital multiplier so that the drive current digital sensing signal DIVCM is generated from the output of the digital amplifier 1063. This makes it possible to sufficiently reduce an error component included in the drive current digital sensing signal DIVCM generated from the output of the digital amplifier 1063 in the offset calibration section 106.

### <<Amplifier Gain Setup for Drive Current Sensing Amplifier>>

FIG. 9 is a diagram illustrating how the coil drive current Ivcm of the voice coil motor (VCM) of the semiconductor integrated circuit IC depicted in FIG. 8 is set by the digital drive current command value VCMCRNT and the digital control signal VCMFS, which are supplied from the external microcomputer or other controller through the serial input/output interface 107.

The horizontal axis of FIG. 9 represents the digital drive current command value VCMCRNT supplied to the digital difference generation/phase compensation control section 100. The vertical axis of FIG. 9 represents the coil drive current Ivcm of the voice coil motor (VCM).

As depicted in FIG. 9, when the digital control signal VCMFS supplied from the serial input/output interface 107 to the drive current sensing amplifier 103 is at high level “1”, the drive current sensing amplifier 103 is placed in a high-gain state so that the coil drive current Ivcm of the voice coil motor (VCM) is in a small-amplitude (full scale small) state with respect to the digital drive current command value VCMCRNT. When, on the contrary, the digital control signal VCMFS supplied from the serial input/output interface 107 to the drive current sensing amplifier 103 is at low level “0”, the drive current sensing amplifier 103 is placed in a low-gain state so that the coil drive current Ivcm of the voice coil motor (VCM) is in a large-amplitude (full scale large) state with respect to the digital drive current command value VCMCRNT.

In other words, when the digital control signal VCMFS is at high level “1”, the resistance values of the feedback resistors 1033, 1035 are set at a high ratio with respect to the input resistors 1032, 1034 in the drive current sensing amplifier 103. When, on the contrary, the digital control signal VCMFS is at low level “0”, the resistance values of the feedback resistors 1033, 1035 are set at a low ratio with respect to the input resistors 1032, 1034 in the drive current sensing amplifier 103.

As depicted in FIG. 9, the maximum value of the digital drive current command value VCMCRNT is “3FFF” in hexadecimal or “16383” in decimal, the minimum value of the digital drive current command value VCMCRNT is “4000” in hexadecimal or “−16384” in decimal, and the intermediate value of the digital drive current command value VCMCRNT is “0000” in hexadecimal or “0” in decimal.

When the digital control signal VCMFS is at low level “0”, the coil drive current Ivcm of the voice coil motor (VCM) is a positive full-scale current Ifs0 in response to the maximum value of the digital drive current command value VCMCRNT, and is a negative full-scale current −Ifs0 in response to the minimum value of the digital drive current command value VCMCRNT.

When the digital control signal VCMFS is at high level “1”, the coil drive current Ivcm of the voice coil motor (VCM) is a positive ¼ full-scale current Ifs0/4 in response to the maximum value of the digital drive current command value VCMCRNT, and is a negative ¼ full-scale current −Ifs0/4 in response to the minimum value of the digital drive current command value VCMCRNT.

No matter whether the digital control signal VCMFS is at high level “1” or low level “0”, the coil drive current Ivcm of the voice coil motor (VCM) is 0 [A] in response to the intermediate value of the digital drive current command value VCMCRNT.

Meanwhile, a state where the digital control signal VCMFS is at low level “0” is used in a seek operation in which the magnetic head is moved to a desired storage track. When the seek operation is to be performed, the speed of the magnetic head needs to be adequately accelerated in order to move the magnetic head to the desired storage track. Therefore, this state in which the full scale of the coil drive current Ivcm is maximized is used to adequately increase the coil drive current Ivcm of the voice coil motor (VCM).

On the other hand, a state where the digital control signal VCMFS is at high level “1” is used in a tracking operation in which the magnetic head is moved to follow a desired storage track for a read/write operation. When the tracking operation is to be performed, the speed of the magnetic head needs to be adequately reduced in order to provide high-precision position control. Therefore, the coil drive current Ivcm of the voice coil motor (VCM) needs to be highly accurate. Hence, when the digital control signal VCMFS is at high level “1”, the amplifier gain of the drive current sensing amplifier 103 is placed in the high-gain state, and the full scale of the drive current Ivcm is set at ¼. Thus, when the full scale of the coil drive current Ivcm is set at ¼, the resolution of the coil drive current Ivcm per LSB of the digital drive current command value VCMCRNT can be made higher than when the full scale of the drive current Ivcm is set at 1. Further, the signal-to-noise ratio and noise characteristics of the whole control loop for the voice coil motor (VCM) can be improved. As described above, when the state where the digital control signal VCMFS is at high level “1” is used, enhanced control accuracy can be achieved in a tracking operation that is performed to move the magnetic head so as to follow a desired storage track for a read/write operation.

However, studies conducted by the inventors of the present invention before the disclosure of the present invention revealed that a significant burden is placed on the design engineer of a hard disk drive when the semiconductor integrated circuit IC configured as depicted in FIG. 8 is used to set the amplifier gain of the drive current sensing amplifier 103 in a manner depicted in FIG. 9.

More specifically, a significant burden is placed on the design engineer because the digital control signal VCMFS at high level “1” for placing the drive current sensing amplifier 103 in the high-gain state and the digital control signal VCMFS at low level “0” for placing the drive current sensing amplifier 103 in the low-gain state need to be supplied to the serial input/output interface 107 from the outside of the semiconductor integrated circuit IC.

In general, various control signals are supplied to the serial input/output interface 107 from a controller such as a microcomputer external to the semiconductor integrated circuit IC. Therefore, the digital control signal VCMFS also needs to be supplied from such an external controller to the serial input/output interface 107. Hence, the digital control signal VCMFS needs to be selectively placed at high level “1” or at low level “0” at a timing at which a seek operation, a tracking operation, or other operation is performed by a hard disk drive (HDD) in which the semiconductor integrated circuit IC depicted in FIG. 8 is mounted. As such being the case, control software for the external microcomputer or other relevant controller needs to be controlled so as to selectively place the digital control signal VCMFS at high level “1” or at low level “0”.

Means for solving the above problem will be described below. Other problems and novel features will become apparent from the following description and from the accompanying drawings.

The following is a brief description of a representative aspect of the present invention disclosed in this document.

In a motor drive control device according to the representative aspect, a drive current sensing amplifier (103) generates a drive current analog sensing signal (AIVCM) in response to a drive current (Ivcm) flowing in a sensing resistor (Rs).

An analog-to-digital converter (104) generates a drive current digital sensing signal (DIVCM) in response to the drive current analog sensing signal (AIVCM) generated by the drive current sensing amplifier (103).

A digital control section (100) generates a digital drive voltage command signal (DDRV), which is to be supplied to the input terminal of a digital-to-analog converter (101), in response to a digital drive current command value (VCMCRNT) supplied from an interface (107) and to the drive current digital sensing signal (DIVCM) generated from the analog-to-digital converter (104).

The digital-to-analog converter (101) generates an analog drive voltage command signal (ADRV), which is to be supplied to the input terminal of a driver output section (102), in response to the digital drive voltage command signal (DDRV) generated from the digital control section (100).

The driver output section (102) generates a drive output signal, which drives a series coupling between a motor (VCM) and the sensing resistor (Rs), in response to the analog drive voltage command signal (ADRV) generated from the digital-to-analog converter (101).

In response to the digital drive current command value (VCMCRNT) that is between a positive predetermined threshold voltage and a negative predetermined threshold voltage, a computation section (108) generates an internal control signal (VCMFS_i) that is in a first state (“1”), and exercises control so as to place the gain of the drive current sensing amplifier (103) in a first state (“H”).

In response to the digital drive current command value that is not between the positive predetermined threshold voltage and the negative predetermined threshold voltage, the computation section (108) generates an internal control signal that is in a second state (“0”), which is different from the first state (“1”), and exercises control so as to place the gain of the drive current sensing amplifier (103) in a second state (“L”), which is lower than the first state (“H”) (see FIG. 1).

The following is a brief description of an advantageous effect achievable by the representative aspect of the present invention disclosed in this document.

The motor drive control device makes it possible to reduce a burden that is placed on a design engineer of a hard disk drive or the like.

### BRIEF DESCRIPTION OF THE DRAWINGS

FIG. 1 is a diagram illustrating the configuration of a semiconductor integrated circuit according to a first embodiment of the present invention, which is a so-called voice coil driver IC for driving a voice coil motor (VCM) that moves a magnetic head of a hard disk drive (HDD);

FIG. 2 is a diagram illustrating an operation of a digital computation section of the semiconductor integrated circuit according to the first embodiment, which is depicted in FIG. 1;

FIG. 3 is a diagram illustrating an operation of the semiconductor integrated circuit according to the first embodiment, which is depicted in FIG. 1;

FIG. 4 is a diagram illustrating a mechanism in which spike noise occurs in a coil drive current and current difference information when an internal digital control signal switches between high level “1” and low level “0” in the semiconductor integrated circuit according to the first embodiment, which is depicted in FIGS. 1 to 3;

FIG. 5 is a diagram illustrating the configuration of the semiconductor integrated circuit according to a second embodiment of the present invention, which is the so-called voice coil driver IC for driving the voice coil motor (VCM) that moves the magnetic head of a hard disk drive (HDD);

FIG. 6 is a diagram illustrating an operation of a mask control signal generation section included in the semiconductor integrated circuit according to the second embodiment, which is depicted in FIG. 5;

FIG. 7 is a diagram illustrating how the spike noise in the coil drive current and current difference information is reduced in response to a mask control signal generated by the mask control signal generation section of the semiconductor integrated circuit according to the second embodiment, which is depicted in FIG. 5;

FIG. 8 is a diagram illustrating the configuration of a voice coil motor driver, which is a semiconductor integrated circuit studied by the inventors of the present invention before the disclosure of the present invention; and

FIG. 9 is a diagram illustrating how the drive current of the voice coil motor (VCM) of the semiconductor integrated circuit depicted in FIG. 8 is set by a digital drive current command value and a digital control signal that are supplied from an external microcomputer or other controller through a serial input/output interface.

### DETAILED DESCRIPTION

### 1. Overview of Embodiments

First of all, representative embodiments of the present invention disclosed in this document will be summarized. The parenthesized reference numerals in the accompanying drawings referred to in the overview of the representative embodiments merely illustrate what is contained in the concept of elements to which the reference numerals are affixed.

[1] A motor drive control device according to a representative embodiment includes a digital control section (100), a digital-to-analog converter (101), a driver output section (102), a drive current sensing amplifier (103), an analog-to-digital converter (104), an interface (107), and a computation section (108).

The output terminal of the driver output section (102) can be coupled to a series coupling between a motor (VCM) and a sensing resistor (Rs).

The drive current sensing amplifier (103) generates a drive current analog sensing signal (AIVCM) in response to a drive current (Ivcm) flowing in the sensing resistor (Rs).

The analog-to-digital converter (104) generates a drive current digital sensing signal (DIVCM) in response to the drive current analog sensing signal (AIVCM) generated by the drive current sensing amplifier (103).

The digital control section (100) generates a digital drive voltage command signal (DDRV), which is to be supplied to the input terminal of the digital-to-analog converter (101), in response to a digital drive current command value (VCMCRNT) supplied from the interface (107) and in response to the drive current digital sensing signal (DIVCM) generated from the analog-to-digital converter (104).

The digital-to-analog converter (101) generates an analog drive voltage command signal (ADRV), which is to be supplied to the input terminal of the driver output section (102), in response to the digital drive voltage command signal (DDRV) supplied from the digital control section (100).

The driver output section (102) generates a drive output signal, which drives the series coupling between the motor (VCM) and the sensing resistor (Rs), in response to the analog drive voltage command signal (ADRV) generated from the digital-to-analog converter (101).

In response to the digital drive current command value (VCMCRNT) that is between a positive predetermined threshold voltage and a negative predetermined threshold voltage, the computation section (108) generates an internal control signal (VCMFS_i) that is in a first state (“1”), and exercises control so as to place the gain of the drive current sensing amplifier (103) in a first gain state (“H”).

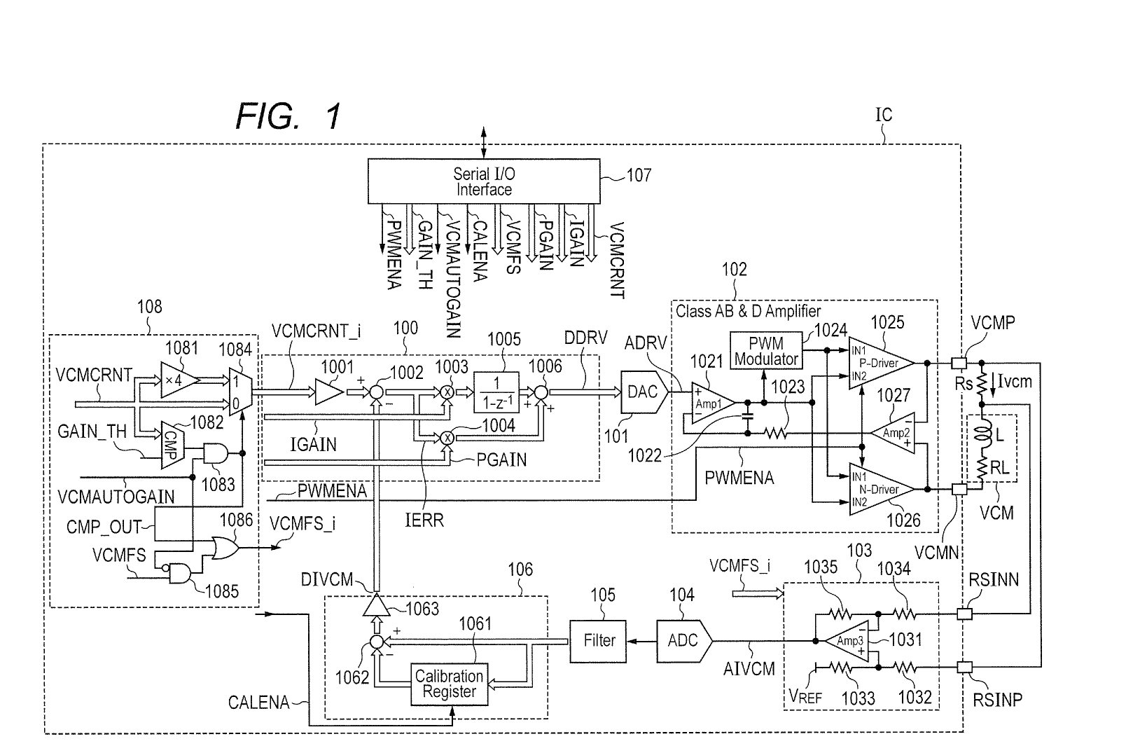

In response to the digital drive current command value that is not between the positive predetermined threshold voltage and the negative predetermined threshold voltage, the computation section (108) generates the internal control signal that is in a second state (“0”), which is different from the first state (“1”), and exercises control so as to place the gain of the drive current sensing amplifier (103) in a second gain state (“L”), which is lower than the first gain state (see FIG. 1).

The above-described embodiment makes it possible to reduce the burden on the design engineer.

In a preferred embodiment, the computation section (108) includes variable digital amplifiers (1081, 1084) and a digital comparator (1082).

The digital comparator (1082) operates as a window comparator in accordance with the digital drive current command value (VCMCRNT), the positive predetermined threshold voltage, and the negative predetermined threshold voltage.

When the digital drive current command value (VCMCRNT) is between the positive predetermined threshold voltage and the negative predetermined threshold voltage, the output signal of the digital comparator (1082) controls the digital gains of the variable digital amplifiers at a predetermined value (×4).

In response to an internal digital drive current command value (VCMCRNT_i) generated from the output terminals of the variable digital amplifiers whose digital gains are controlled at the predetermined value and in response to the drive current digital sensing signal (DIVCM) generated from the analog-to-digital converter (104), the digital control section (100) generates the digital drive voltage command signal (DDRV).

When the digital drive current command value (VCMCRNT) is not between the positive predetermined threshold voltage and the negative predetermined threshold voltage, the output signal of the digital comparator (1082) controls the digital gains of the variable digital amplifiers at a value (×1) smaller than the predetermined value (×4).

In response to the internal digital drive current command value generated from the output terminals of the variable digital amplifiers whose digital gains are controlled at the value smaller than the predetermined value and to the drive current digital sensing signal generated from the analog-to-digital converter, the digital control section (100) generates the digital drive voltage command signal (DDRV) (see FIG. 1).

In another preferred embodiment, the digital control section (100) includes a digital subtractor (1002) and a selector (1007).

The motor drive control device further includes a mask control signal generation section (109). The mask control signal generation section (109) generates a mask control signal (MASK) having a predetermined mask level (“1”) at each timing at which the internal control signal (VCMFS_i) generated from the computation section (108) switches between the first state (“1”) and the second state (“0”).

The digital subtractor (1002) generates digital difference drive current information (IERR) by subtracting the drive current digital sensing signal (DIVCM) generated from the analog-to-digital converter (104) from the internal digital drive current command value (VCMCRNT_i) generated from the computation section (108).

The digital difference drive current information (IERR) generated from the digital subtractor (1002) is supplied to a first input terminal of the selector (1007). A target value (“0”) for the digital difference drive current information (IERR) is supplied to a second input terminal of the selector (1007). The digital drive voltage command signal (DDRV) is generated from the output terminal of the selector (1007).

When the mask control signal (MASK) having the predetermined mask level (“1”), which is generated from the mask control signal generation section (109), is supplied to a selection control terminal of the selector (1007), the target value (“0”) supplied to the second input terminal of the selector is selected and output from the output terminal of the selector (1007) as the digital drive voltage command signal (DDRV).

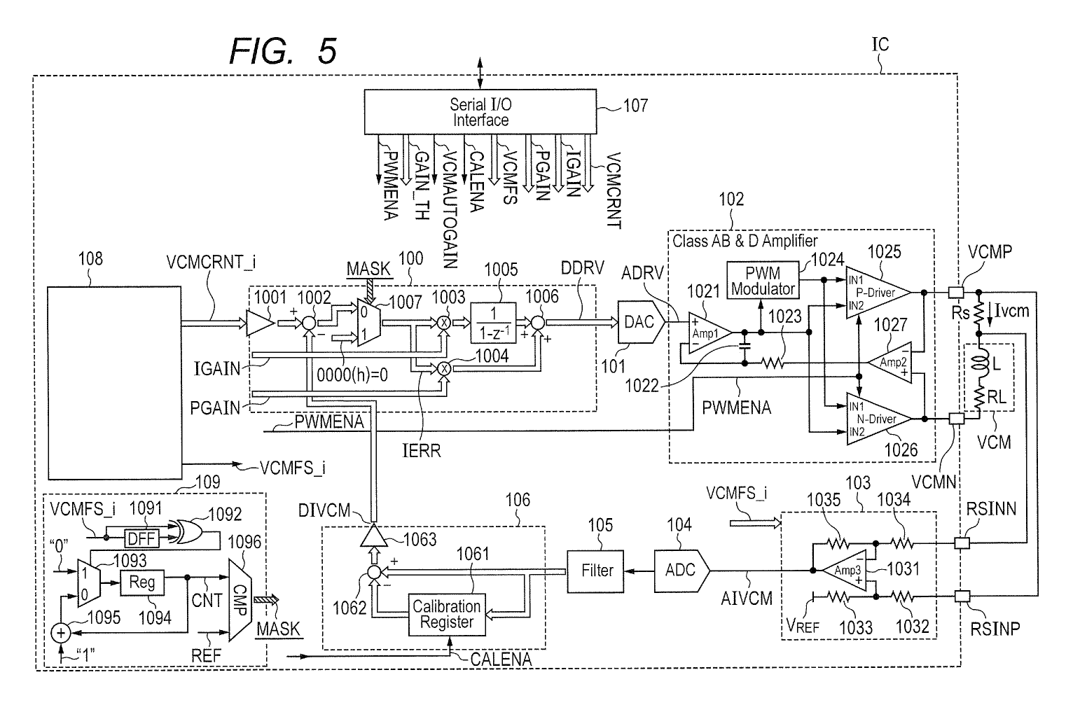

When the mask control signal (MASK) having the predetermined mask level, which is generated from the mask control signal generation section, is not supplied to the selection control terminal of the selector, the digital difference drive current information (IERR) supplied to the first input terminal of the selector is selected and output from the output terminal of the selector as the digital drive voltage command signal (DDRV) (see FIG. 5).

In still another preferred embodiment, the driver output section (102) includes a pre-driver (1021), a first driver output amplifier (1025), and a second driver output amplifier (1026).

The analog drive voltage command signal (ADRV) generated from the digital-to-analog converter (101) is supplied to the input terminal of the pre-driver (1021).

The output terminal of the pre-driver (1021) is coupled to the input terminal of the first driver output amplifier (1025) and to the input terminal of the second driver output amplifier (1026). The output terminal of the first driver output amplifier (1025) and the output terminal of the second driver output amplifier (1026) can be respectively coupled to one end and the other end of the series coupling between the motor (VCM) and the sensing resistor (Rs).

In a pulse drive operation mode, the first driver output amplifier (1025) and the second driver output amplifier (1026) generate a drive pulse having a pulse width proportional to the voltage level of the output terminal of the pre-driver (1021).

In a linear drive mode, which is different from the pulse drive operation mode, the first driver output amplifier (1025) and the second driver output amplifier (1026) generate an amplifier output signal proportional to the voltage level of the output terminal of the pre-driver (1021) (see FIG. 1).

In a more preferred embodiment, a predetermined bias voltage is supplied, in the pulse drive operation mode, to a transistor of the first driver output amplifier (1025) and to a transistor of the second driver output amplifier (1026) so that the first driver output amplifier (1025) and the second driver output amplifier (1026) perform a class D amplifier operation.

In the linear drive mode, on the other hand, a bias voltage higher than the predetermined bias voltage is supplied to the transistor of the first driver output amplifier (1025) and to the transistor of the second driver output amplifier (1026) so that the first driver output amplifier (1025) and the second driver output amplifier (1026) perform a class AB amplifier operation (see FIG. 1).

In another more preferred embodiment, the digital-to-analog converter (101) is a ΣΔ digital-to-analog converter (see FIG. 1).

In yet another more preferred embodiment, the analog-to-digital converter (104) is an oversampling ΣΔ analog-to-digital converter (see FIG. 1).

The motor drive control device according to still another more preferred embodiment further includes a decimation filter (105) that is coupled between the output terminal of the oversampling ΣΔ analog-to-digital converter (104) and the digital subtractor (1002) of the digital control section (100).

The decimation filter (105) performs a decimation process to decimate a converted output signal of the oversampling ΣΔ analog-to-digital converter and a low-pass filter process to suppress quantization noise in a high-frequency region of the oversampling ΣΔ analog-to-digital converter (see FIG. 1).

The motor drive control device according to a specific embodiment further includes an offset calibration section (106) that is coupled between the output terminal of the decimation filter (105) and the digital subtractor (1002) of the digital control section (100).

The offset calibration section (106) includes a calibration register (1061) and an offset digital subtractor (1062).

While the drive current (Ivcm) of the sensing resistor (Rs) is substantially set to zero, error information about the drive current sensing amplifier (103), the analog-to-digital converter (104), and the decimation filter (105) is stored in the calibration register (1061).

During a normal operation, the offset digital subtractor (1062) generates the drive current sensing signal (DIVCM), which is the digital sensing signal to be fed back to the digital subtractor of the digital control section, by subtracting the error information stored in the calibration register (1061) from the output signal of the decimation filter (105) (see FIG. 1).

In a more specific embodiment, the motor is a voice coil motor (VCM) that moves the magnetic head of a hard disk drive (HDD) (see FIG. 1).

In another more specific embodiment, the digital control section, the digital-to-analog converter, the driver output section, the drive current sensing amplifier, the analog-to-digital converter, the decimation filter, the offset calibration section, and the computation section are integrated into a semiconductor chip of a semiconductor integrated circuit (see FIG. 1).

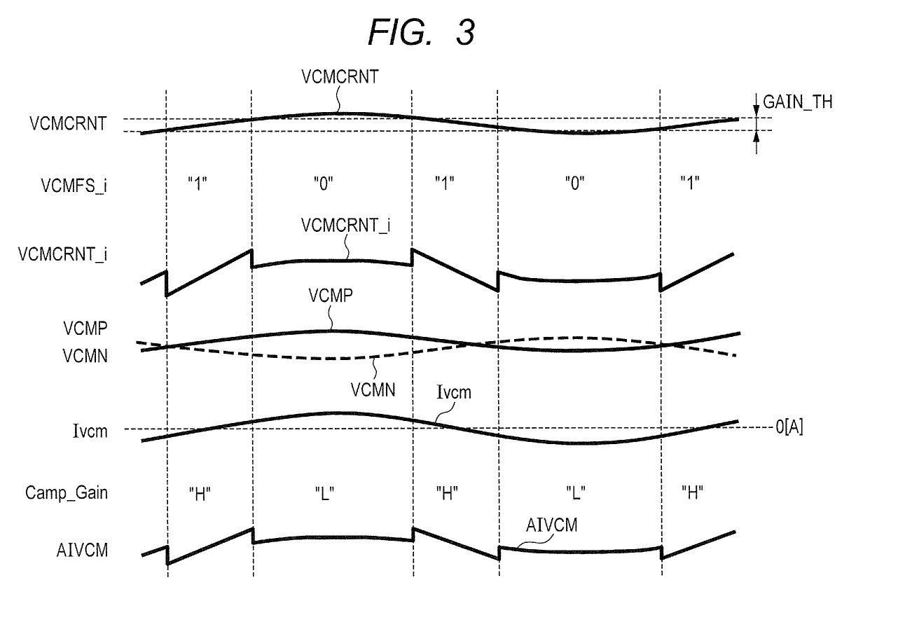

In the most specific embodiment, the mask control signal generation section (109) is additionally integrated into the semiconductor chip of the semiconductor integrated circuit (see FIG. 3).

[2] Another representative embodiment is an operating method for a motor drive control device that includes a digital control section (100), a digital-to-analog converter (101), a driver output section (102), a drive current sensing amplifier (103), an analog-to-digital converter (104), an interface (107), and a computation section (108).

The output terminal of the driver output section (102) can be coupled to a series coupling between a motor (VCM) and a sensing resistor (Rs).

The drive current sensing amplifier (103) generates a drive current analog sensing signal (AIVCM) in response to a drive current (Ivcm) flowing in the sensing resistor (Rs).

The analog-to-digital converter (104) generates a drive current digital sensing signal (DIVCM) in response to the drive current analog sensing signal (AIVCM) generated by the drive current sensing amplifier (103).

The digital control section (100) generates a digital drive voltage command signal (DDRV), which is to be supplied to the input terminal of the digital-to-analog converter (101), in response to a digital drive current command value (VCMCRNT) supplied from the interface (107) and to the drive current digital sensing signal (DIVCM) generated from the analog-to-digital converter (104).

The digital-to-analog converter (101) generates an analog drive voltage command signal (ADRV), which is to be supplied to the input terminal of the driver output section (102), in response to the digital drive voltage command signal (DDRV) supplied from the digital control section (100).

The driver output section (102) generates a drive output signal, which drives the series coupling between the motor (VCM) and the sensing resistor (Rs), in response to the analog drive voltage command signal (ADRV) generated from the digital-to-analog converter (101).

In response to the digital drive current command value (VCMCRNT) that is between a positive predetermined threshold voltage and a negative predetermined threshold voltage, the computation section (108) generates an internal control signal (VCMFS_i) that is in a first state (“1”), and exercises control so as to place the gain of the drive current sensing amplifier (103) in a first gain state (“H”).

In response to the digital drive current command value that is not between the positive predetermined threshold voltage and the negative predetermined threshold voltage, the computation section (108) generates the internal control signal that is in a second state, which is different from the first state, and exercises control so as to place the gain of the drive current sensing amplifier (103) in a second gain state (“L”), which is lower than the first gain state (see FIG. 1).

The above-described embodiment makes it possible to reduce the burden on the design engineer.

### 2. Details of Embodiments

Embodiments of the present invention will now be described in further detail. Throughout the drawings for illustrating the best embodiments for implementing the present invention, parts having the same functions are designated by the same reference numerals and will not be redundantly described.

### First Embodiment

### Configuration Overview of Semiconductor Integrated Circuit

FIG. 1 is a diagram illustrating the configuration of a semiconductor integrated circuit IC according to a first embodiment of the present invention, which is a so-called voice coil driver IC for driving a voice coil motor (VCM) that moves a magnetic head of a hard disk drive (HDD).

More specifically, the voice coil driver IC depicted in FIG. 1 is a high-density semiconductor integrated circuit called a combo driver, which is an integrated circuit having a spindle motor driver and a voice coil motor driver. The spindle motor driver drives a spindle motor that rapidly rotates a magnetic disk. The voice coil motor driver drives the voice coil motor.

A semiconductor chip of the voice coil driver IC according to the first embodiment, which is depicted in FIG. 1, is an integrated chip that includes a digital difference generation/phase compensation control section 100, a digital-to-analog converter 101, a driver output section 102, a drive current sensing amplifier 103, an analog-to-digital converter 104, a decimation filter 105, an offset calibration section 106, a serial input/output interface 107, and a digital computation section 108.

### <<Digital Computation Section>>

The digital computation section 108 is particularly disposed in the semiconductor chip of the semiconductor integrated circuit IC in order to reduce the burden on a design engineer of a hard disk drive or the like. In response to the magnitude of the digital value of a digital drive current command value VCMCRNT, the digital computation section 108 automatically sets the drive current sensing amplifier 103 in a low-gain state or in a high-gain state.

An external controller or the like supplies the digital drive current command value VCMCRNT, a gain threshold voltage GAIN_TH, an automatic gain change command signal VCMAUTOGAIN, and a digital control signal VCMFS to the digital computation section 108 through the serial input/output interface 107.

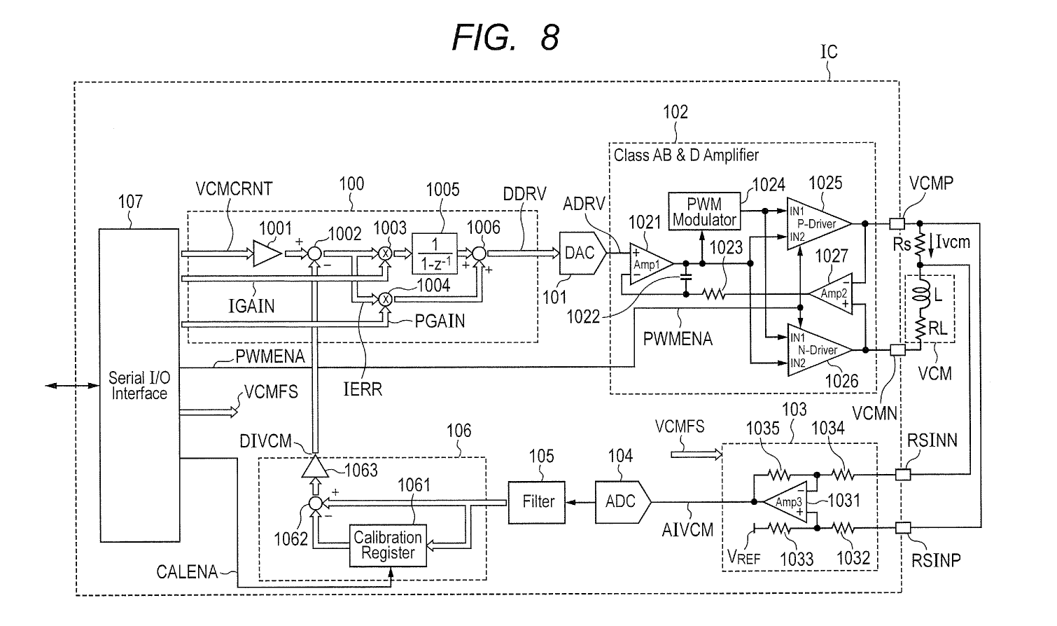

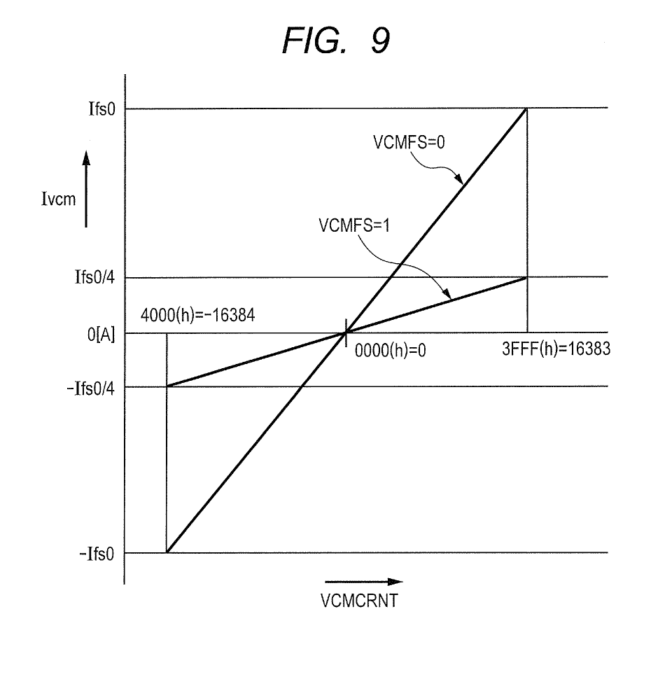

When the semiconductor integrated circuit IC according to the first embodiment, which is depicted in FIG. 1, is operated in the same manner as the semiconductor integrated circuit IC depicted in FIGS. 8 and 9 that was studied by the inventors of the present invention before the disclosure of the present invention, the automatic gain change command signal VCMAUTOGAIN at low level “0” is supplied to the digital computation section 108 through the serial input/output interface 107. In this instance, therefore, the digital control signal VCMFS at low level “0” or at high level “1” is supplied, as an internal digital control signal VCMFS_i, to the drive current sensing amplifier 103 through an AND circuit 1085 and an OR circuit 1086.

When an external digital control signal VCMFS and the internal digital control signal VCMFS_i are at high level “1”, the resistance values of feedback resistors 1033, 1035 are set at a high ratio with respect to input resistors 1032, 1034 in the drive current sensing amplifier 103. Therefore, the drive current sensing amplifier 103 is placed in the high-gain state, and a drive current analog sensing signal AIVCM of the drive current sensing amplifier 103 is placed in a large-amplitude state.

When, on the contrary, the external digital control signal VCMFS and the internal digital control signal VCMFS_i are at low level “0”, the resistance values of the feedback resistors 1033, 1035 are set at a low ratio with respect to the input resistors 1032, 1034 in the drive current sensing amplifier 103. Therefore, the drive current sensing amplifier 103 is placed in the low-gain state, and the drive current analog sensing signal AIVCM of the drive current sensing amplifier 103 is placed in a small-amplitude state.

In order to permit the semiconductor integrated circuit IC according to the first embodiment, which is depicted in FIG. 1, to truly operate as the semiconductor integrated circuit IC according to the first embodiment, the automatic gain change command signal VCMAUTOGAIN at high level “1” is supplied to the digital computation section 108 through the serial input/output interface 107. Hence, in this instance, the output signal of the AND circuit 1085 is at low level “0” no matter whether the digital control signals VCMFS are at low level “0” or at high level “1”. Further, in this instance, the digital comparator 1082 compares the digital drive current command value VCMCRNT with the gain threshold voltage GAIN_TH. The gain threshold voltage GAIN_TH includes a positive predetermined threshold voltage, which is “FFF” in hexadecimal or “4095” in decimal, and a negative predetermined threshold voltage, which is “1000” in hexadecimal or “−4096” in decimal. The digital comparator 1082 operates as a window comparator by using the positive and negative predetermined threshold voltages for the digital drive current command value VCMCRNT. More specifically, if the digital drive current command value VCMCRNT is between the positive and negative predetermined threshold voltages of the gain threshold voltage GAIN_TH, the output signal of the digital comparator 1082, which operates as the window comparator, is at high level “1”. However, if the digital drive current command value VCMCRNT is greater than the positive predetermined threshold voltage of the gain threshold voltage GAIN_TH or smaller than the negative predetermined threshold voltage of the gain threshold voltage GAIN_TH, the output signal of the digital comparator 1082, which operates as the window comparator, is at low level “0”.

The digital drive current command value VCMCRNT is forwarded through the serial input/output interface 107, amplified by a fixed gain of “4” by a digital amplifier 1081 formed of a digital multiplier, and supplied to a first input terminal of a selector 1084. At the same time, the digital drive current command value VCMCRNT is directly supplied to a second input terminal of the selector 1084. The output signal of the digital comparator 1082, which operates as the window comparator, and the automatic gain change command signal VCMAUTOGAIN are respectively supplied to first and second input terminals of an AND circuit 1083, and the output signal CMP_OUT of the AND circuit 1083 is supplied to a selection control input terminal of the selector 1084.

When the automatic gain change command signal VCMAUTOGAIN is at high level “1” and the digital drive current command value VCMCRNT is between the positive and negative predetermined threshold voltages of the gain threshold voltage GAIN_TH, the output signal of the digital comparator 1082, which operates as the window comparator, and the output signal of the AND circuit 1083 are at high level “1”. Therefore, the selector 1084 supplies the digital drive current command value VCMCRNT, which is amplified by a fixed gain of “4” of the digital amplifier 1081, to the digital difference generation/phase compensation control section 100 as the internal digital drive current command value VCMCRNT_i. Further, as the output signal CMP_OUT of the AND circuit 1083 is at high level “1”, the internal digital control signal VCMFS_i, which is generated from the output terminal of the OR circuit 1086 and at high level “1”, is supplied to the drive current sensing amplifier 103. As a result, the drive current sensing amplifier 103 is set in the high-gain state in response to the internal digital control signal VCMFS_i at high level “1”. As this high-gain state sets the full scale of the coil drive current Ivcm of the voice coil motor VCM in a small state, the resolution of current control of the coil drive current Ivcm of the voice coil motor VCM increases with respect to the digital drive current command value VCMCRNT. This makes it possible to provide increased accuracy in controlling a tracking operation that is performed to move the magnetic head of the hard disk drive (HDD) so as to follow a desired storage track for a read/write operation.

When the automatic gain change command signal VCMAUTOGAIN is at high level “1” and the digital drive current command value VCMCRNT is greater than the positive predetermined threshold voltage of the gain threshold voltage GAIN_TH or smaller than the negative predetermined threshold voltage of the gain threshold voltage GAIN_TH, the output signal of the digital comparator 1082, which operates as the window comparator, and the output signal of the AND circuit 1083 are at low level “0”. Therefore, the digital drive current command value VCMCRNT, which is directly supplied to the second input terminal of the selector 1084, is selected by the selector 1084 and supplied to the digital difference generation/phase compensation control section 100 as the internal digital drive current command value VCMCRNT_i. Further, as the output signal CMP_OUT of the AND circuit 1083 is at low level “0”, the internal digital control signal VCMFS_i, which is generated from the output terminal of the OR circuit 1086 and at low level “0”, is supplied to the drive current sensing amplifier 103. As a result, the drive current sensing amplifier 103 is set in the low-gain state in response to the internal digital control signal VCMFS_i at low level “0”. This low-gain state sets the full scale of the coil drive current Ivcm of the voice coil motor VCM in a large state. Consequently, a larger coil drive current Ivcm is obtained to apply adequate torque to the magnetic head. This makes it possible to increase the speed of the magnetic head of the hard disk drive (HDD) when the magnetic head is moved to a desired storage track.

### <<Operation of Digital Computation Section>>

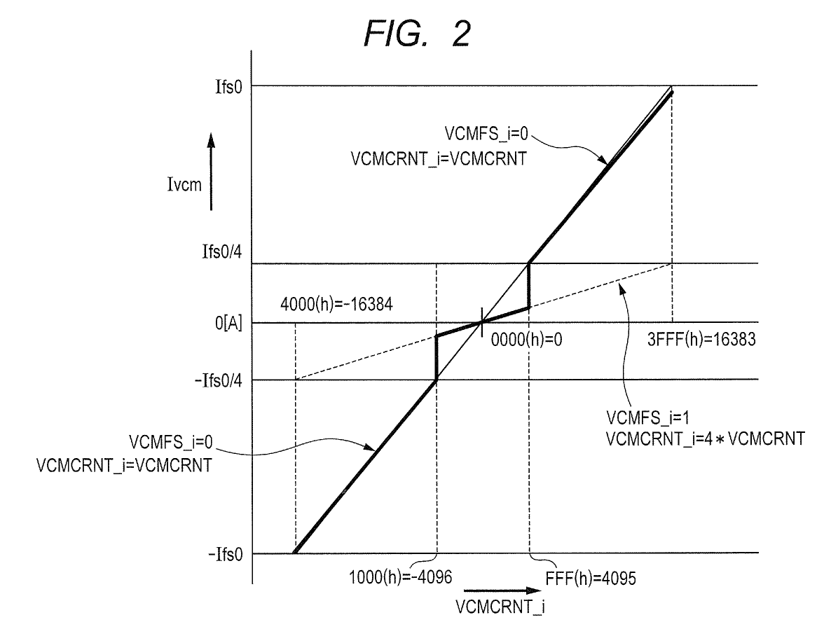

FIG. 2 is a diagram illustrating an operation of the digital computation section 108 of the semiconductor integrated circuit IC according to the first embodiment, which is depicted in FIG. 1.

The horizontal axis of FIG. 2 represents the internal digital drive current command value VCMCRNT_i, which is supplied from the digital computation section 108 of the semiconductor integrated circuit IC to the digital difference generation/phase compensation control section 100. The vertical axis of FIG. 2 represents the coil drive current Ivcm of the voice coil motor (VCM). Here, it is assumed that the automatic gain change command signal VCMAUTOGAIN is set at high level “1”.

When the internal digital drive current command value VCMCRNT_i is between the positive predetermined threshold voltage (“FFF” in hexadecimal or “4095” in decimal) and negative predetermined threshold voltage (“1000” in hexadecimal or “−4096” in decimal) of the gain threshold voltage GAIN_TH, the internal digital control signal VCMFS_i generated from the digital computation section 108 is at high level “1”. In this instance, therefore, the drive current sensing amplifier 103 is set in the high-gain state in response to the internal digital control signal VCMFS_i at high level “1” as depicted in FIG. 2, and the full-scale range of the coil drive current Ivcm of the voice coil motor (VCM) is set at ¼. In this high-gain state, the internal digital drive current command value VCMCRNT_i is four times the digital drive current command value VCMCRNT. Therefore, the value of the coil drive current Ivcm does not change when the internal digital control signal VCMFS_i changes. However, as the full-scale range of the coil drive current Ivcm is reduced to ¼, the change in the coil drive current Ivcm of the voice coil motor VCM with respect to a change in the digital drive current command value VCMCRNT becomes small. Thus, the resolution of current control of the coil drive current Ivcm of the voice coil motor VCM increases with respect to the digital drive current command value VCMCRNT. This makes it possible to provide increased accuracy in controlling the tracking operation that is performed to move the magnetic head of the hard disk drive (HDD) so as to follow a desired storage track for a read/write operation.

Let us assume a case where the internal digital control signal VCMFS_i is between the positive predetermined threshold voltage (“FFF” in hexadecimal or “4095” in decimal) of the gain threshold voltage GAIN_TH and the maximum value (“3FFF” in hexadecimal or “16383” in decimal) of the internal digital control signal VCMFS_i, as depicted in FIG. 2. In addition, let assume a case where the internal digital control signal VCMFS_i is between the negative predetermined threshold voltage (“1000” in hexadecimal or “−4096” in decimal) of the gain threshold voltage GAIN_TH and the minimum value (“4000” in hexadecimal or “−16384” in decimal) of the internal digital control signal VCMFS_i, as depicted in FIG. 2. As a result, in both of the above two cases, the internal digital control signal VCMFS_i generated from the digital computation section 108 is at low level “0”. In this instance, therefore, the drive current sensing amplifier 103 is set in the low-gain state in response to the internal digital control signal VCMFS_i at low level “0”. In this low-gain state, the full-scale range of the coil drive current Ivcm of the voice coil motor VCM set in a large state. As a result, a large coil drive current Ivcm flows to obtain a torque that sufficiently accelerates the magnetic head. This makes it possible to increase the speed of the magnetic head of the hard disk drive (HDD) when a seek operation is performed to move the magnetic head to a desired storage track.

### <<Operation of Semiconductor Integrated Circuit>>

FIG. 3 is a diagram illustrating an operation of the semiconductor integrated circuit IC according to the first embodiment, which is depicted in FIG. 1.

A first portion of FIG. 3 depicts the waveform of the digital drive current command value VCMCRNT, which is supplied from the serial input/output interface 107 to the digital difference generation/phase compensation control section 100, and the waveform of the gain threshold voltage GAIN_TH. The upper broken line of the gain threshold voltage GAIN_TH represents the positive predetermined threshold voltage (“FFF” in hexadecimal or “4095” in decimal). The lower broken line of the gain threshold voltage GAIN_TH represents the negative predetermined threshold voltage (“1000” in hexadecimal or “−4096” in decimal).

A second portion of FIG. 3 depicts the waveform of the internal digital control signal VCMFS_i, which is supplied from the digital computation section 108 to the drive current sensing amplifier 103. When the digital drive current command value VCMCRNT is between the positive predetermined threshold voltage (“FFF” in hexadecimal or “4095” in decimal) and negative predetermined threshold voltage (“1000” in hexadecimal or “−4096” in decimal) of the gain threshold voltage GAIN_TH, the internal digital control signal VCMFS_i generated from the digital computation section 108 is at high level “1”. When the digital drive current command value VCMCRNT is greater than the positive predetermined threshold voltage of the gain threshold voltage GAIN_TH or smaller than the negative predetermined threshold voltage of the gain threshold voltage GAIN_TH, the internal digital control signal VCMFS_i generated from the digital computation section 108 is at low level “0”.

A third portion of FIG. 3 depicts the waveform of the internal digital drive current command value VCMCRNT_i, which is supplied from the digital computation section 108 to the digital difference generation/phase compensation control section 100. While the internal digital control signal VCMFS_i is at high level “1”, the internal digital drive current command value VCMCRNT_i represents a large digital amplitude that is amplified by a fixed gain of “4” of the digital amplifier 1081. While the internal digital control signal VCMFS_i is at low level “0”, the internal digital drive current command value VCMCRNT_i represents a small digital amplitude of the digital drive current command value VCMCRNT that is directly supplied to the second input terminal of the selector 1084.

A fourth portion of FIG. 3 depicts the waveforms of the first and second VCM driver output terminals VCMP, VCMN of the driver output section 102 of the semiconductor integrated circuit IC.

A fifth portion of FIG. 3 depicts the waveform of the coil drive current Ivcm flowing in the current sensing resistor Rs, which is series-coupled to the voice coil motor (VCM). While the internal digital control signal VCMFS_i is at high level “1”, the coil drive current Ivcm is approximately 0 [A]. On the other hand, while the internal digital control signal VCMFS_i is at low level “0”, the coil drive current Ivcm is a positive current larger than approximately 0 [A] or a negative current smaller than approximately 0 [A].

A sixth portion of FIG. 3 depicts changes in the amplifier gain Camp_Gain of the drive current sensing amplifier 103.

While the internal digital control signal VCMFS_i is at high level “1”, the amplifier gain Camp_Gain of the drive current sensing amplifier 103 is in the high-gain state “H”. While the internal digital control signal VCMFS_i is at low level “0”, the amplifier gain Camp_Gain of the drive current sensing amplifier 103 is in the low-gain state “L”.

A seventh portion of FIG. 3 depicts the waveform of the drive current analog sensing signal AIVCM, which is generated from the output terminal of the drive current sensing amplifier 103.

While the internal digital control signal VCMFS_i is at high level “1”, the drive current analog sensing signal AIVCM is a large-amplitude analog signal in response to the high-gain state “H” of the amplifier gain Camp_Gain of the drive current sensing amplifier 103.

While the internal digital control signal VCMFS_i is at low level “0”, the drive current analog sensing signal AIVCM is a small-amplitude analog signal in response to the low-gain state “L” of the amplifier gain Camp_Gain of the drive current sensing amplifier 103.

### <<Detailed Configuration of Semiconductor Integrated Circuit>>

The configuration of the semiconductor integrated circuit IC according to the first embodiment, which is depicted in FIG. 1, will now be described in detail.

### <<Serial Input/Output Interface>>

The digital drive current command value VCMCRNT, integration gain information IGAIN, proportional gain information PGAIN, a PWM operation enable signal PWMENA, the digital control signal VCMFS, and a calibration enable signal CALENA are supplied to the serial input/output interface 107 from, for example, a microcomputer external to the semiconductor integrated circuit IC.

The serial input/output interface 107 supplies the digital drive current command value VCMCRNT, the integration gain information IGAIN, and the proportional gain information PGAIN to the digital difference generation/phase compensation control section 100. The serial input/output interface 107 supplies the PWM operation enable signal PWMENA to the driver output section 102. The serial input/output interface 107 supplies the digital control signal VCMFS to the digital computation section 108. The serial input/output interface 107 supplies the calibration enable signal CALENA to the offset calibration section 106.

Further, the serial input/output interface 107 supplies the gain threshold voltage GAIN_TH and the automatic gain change command signal VCMAUTOGAIN to the digital computation section 108.

### <<Digital Computation Section>>

As depicted in FIG. 1, the digital computation section 108 includes the digital amplifier 1081 formed of a digital multiplier, the digital comparator 1082, the AND circuit 1083, the selector 1084, the AND circuit 1085, and the OR circuit 1086.

The serial input/output interface 107 supplies the digital drive current command value VCMCRNT to the input terminal of the digital amplifier 1081 formed of a digital multiplier, to the second input terminal of the selector 1084, and to the first input terminal of the digital comparator 1082. A digital amplifier output signal, which is amplified by a fixed gain of “4” by the digital amplifier 1081, is supplied to the first input terminal of the selector 1084. The internal digital drive current command value VCMCRNT_i, which is generated from the output terminal of the selector 1084, is supplied to the digital difference generation/phase compensation control section 100. The serial input/output interface 107 supplies the gain threshold voltage GAIN_TH to the second input terminal of the digital comparator 1082.

A comparator output signal of the digital comparator 1082 and the automatic gain change command signal VCMAUTOGAIN from the serial input/output interface 107 are respectively supplied to the first and second input terminals of the AND circuit 1083. The output signal CMP_OUT of the AND circuit 1083 is supplied to the selection control input terminal of the selector 1084 and to a first input terminal of the OR circuit 1086.

The serial input/output interface 107 supplies the automatic gain change command signal VCMAUTOGAIN and the digital control signal VCMFS to an inverting first input terminal and second input terminal of the AND circuit 1085, respectively. The output signal of the AND circuit 1085 is supplied to a second input terminal of the OR circuit 1086. The internal digital control signal VCMFS_i is generated from the output terminal of the OR circuit 1086 and supplied to the drive current sensing amplifier 103.

### <<Digital Difference Generation/Phase Compensation Control Section>>

The digital difference generation/phase compensation control section 100 includes a digital amplifier 1001 formed of a digital multiplier, a digital subtractor 1002, two digital multipliers 1003, 1004, a digital integrator 1005, and a digital adder 1006.

The digital difference generation/phase compensation control section 100 generates current difference information IERR, which represents the difference between command information about the digital drive current command value VCMCRNT_i supplied from the digital computation section 108 and feedback information about a drive current digital sensing signal DIVCM generated from voice coil motor drive current information of the drive current sensing amplifier 103, and generates the drive voltage command signals DDRV, ADRV.

The digital amplifier 1001, which is formed of a digital multiplier, digitally amplifies the internal digital drive current command value VCMCRNT_i, which is supplied from the serial input/output interface 107 and the digital computation section 108. The internal digital drive current command value VCMCRNT_i, which is digitally amplified by the digital amplifier 1001, is supplied to one input terminal of the digital subtractor 1002, and the drive current digital sensing signal DIVCM, which is generated from a digital amplifier 1063 of the offset calibration section 106, is supplied to the other input terminal of the digital subtractor 1002. As a result, digital difference drive current information IERR, which is generated from the output terminal of the digital subtractor 1002, is supplied to one input terminal of the digital multiplier 1003 and to one input terminal of the digital multiplier 1004.

The integration gain information IGAIN and the proportional gain information PGAIN are stored beforehand in two control registers of the serial input/output interface 107 by the external microcomputer or other controller. Therefore, the integration gain information IGAIN and the proportional gain information PGAIN are supplied from the serial input/output interface 107 to the other input terminal of the digital multiplier 1003 and to the other input terminal of the digital multiplier 1004, respectively. As a result, the digital multiplier 1003 multiplies the digital difference drive current information IERR of the digital subtractor 1002 by the integration gain information IGAIN of the serial input/output interface 107 and supplies the result of multiplication to the input terminal of the digital integrator 1005. Further, the digital multiplier 1004 multiplies the digital difference drive current information IERR of the digital subtractor 1002 by the proportional gain information PGAIN of the serial input/output interface 107 and supplies the result of multiplication to one input terminal of the digital adder 1006. Furthermore, digital difference drive current integration information is supplied from the output terminal of the digital integrator 1005 to the other input terminal of the digital adder 1006, and digital difference drive current proportional information is supplied from the output terminal of the digital multiplier 1004 to one input terminal of the digital adder 1006. Therefore, digital difference dive current proportional integration information (proportional integration information), which is generated from the output terminal of the digital adder 1006 of the digital difference generation/phase compensation control section 100 as a digital drive voltage command signal DDRV, is supplied to the input terminal of the digital-to-analog converter 101.

### <<Digital-to-Analog Converter>>

In the semiconductor integrated circuit IC according to FIG. 1, which is depicted in FIG. 1, the digital drive voltage command signal DDRV, which is generated from the output terminal of the digital adder 1006 of the digital difference generation/phase compensation control section 100, is converted to an analog drive voltage command signal ADRV by the digital-to-analog converter 101 and supplied to the input terminal of the driver output section 102.

A ΣΔ digital-to-analog converter capable of performing high-resolution digital-to-analog conversion at high speed is employed as the digital-to-analog converter 101. As the ΣΔ digital-to-analog converter is mostly formed of a digital circuit, low power consumption and high speed can be achieved by an ultra-small semiconductor manufacturing process for the semiconductor integrated circuit IC. Further, in the ΣΔ digital-to-analog converter, the difference between a converted output signal and an input signal is generated by ΣΔ modulation. The generated difference is then integrated. The resulting integrated value is eventually minimized by performing a feedback process. As a result, quantization noise included in the output of a comparator in the ΣΔ digital-to-analog converter is shifted to a high frequency region due to the so-called noise shaping effect. This makes it possible to achieve a high signal-to-noise ratio.

### <<Driver Output Section>>

In the semiconductor integrated circuit IC according to the first embodiment, which is depicted in FIG. 1, the driver output section 102 drives the current sensing resistor Rs and the voice coil motor (VCM), which are coupled between the first VCM driver output terminal VCMP and the second VCM driver output terminal VCMN, in response to the analog drive voltage command signal ADRV from the digital-to-analog converter 101. The voice coil motor (VCM) includes the coil L and the parasitic resistor RL, which are coupled in series.

As depicted in FIG. 1, the driver output section 102 includes a pre-driver 1021, a feedback capacitor 1022, a feedback resistor 1023, a PWM modulator 1024, a first VCM driver output amplifier 1025, a second VCM driver output amplifier 1026, and a feedback amplifier 1027.

The analog drive voltage command signal ADRV from the digital-to-analog converter 101 is supplied to a non-inverting input terminal+ of the pre-driver 1021, and a feedback output signal of the feedback amplifier 1027 is supplied to an inverting input terminal− of the pre-driver 1021 through the feedback capacitor 1022 and the feedback resistor 1023. The output terminal of the pre-driver 1021 is coupled to the input terminal of the PWM modulator 1024. The output terminal of the PWM modulator 1024 is coupled to a first input terminal In1 of the first VCM driver output amplifier 1025 and to a first input terminal In1 of the second VCM driver output amplifier 1026. The output signal of the pre-driver 1021 is supplied to a second input terminal In2 of the first VCM driver output amplifier 1025 and to a second input terminal In2 of the second VCM driver output amplifier 1026.

The output terminal of the first VCM driver output amplifier 1025 is coupled to the first VCM driver output terminal VCMP and to an inverting input terminal− of the feedback amplifier 1027. The output terminal of the second VCM driver output amplifier 1026 is coupled to the second VCM driver output terminal VCMN and to a non-inverting input terminal+ of the feedback amplifier 1027.

Further, the PWM operation enable signal PWMENA is supplied from the external microcomputer or other controller to the first VCM driver output amplifier 1025 and the second VCM driver output amplifier 1026 through the serial input/output interface 107.

When a high-level PWM operation enable signal PWMENA is supplied, the first VCM driver output amplifier 1025 and the second VCM driver output amplifier 1026 respond to a triangular wave PWM carrier signal supplied from the PWM modulator 1024 to the first input terminal In1 and to a pre-driver output signal supplied from the pre-driver 1021 to the second input terminal In2. Therefore, the first VCM driver output amplifier 1025 and the second VCM driver output amplifier 1026 generate a drive pulse output signal having a pulse width proportional to the voltage level of the pre-driver output signal of the pre-driver 1021. In such an instance, a small bias voltage is supplied to amplifying transistors of the first VCM driver output amplifier 1025 and the second VCM driver output amplifier 1026 in response to the high-level PWM operation enable signal PWMENA. Hence, the amplifying transistors can perform a class D amplifier operation to reduce their power consumption.

Drive pulse output signals having opposite phases are generated from the first VCM driver output amplifier 1025 and the second VCM driver output amplifier 1026. The drive pulse output signals having opposite phases drive both terminals of the voice coil motor (VCM). A pulse drive mode based on PWM control in which a drive pulse width varies is suitable, for instance, for a seek operation and other operations in which the magnetic head is driven to move to a large extent.

When a low-level PWM operation enable signal PWMENA is supplied, the first VCM driver output amplifier 1025 and the second VCM driver output amplifier 1026 enter a linear drive mode, which generates an amplifier output signal proportional to the voltage level of the pre-driver output signal of the pre-driver 1021. In this case, therefore, the first VCM driver output amplifier 1025 and the second VCM driver output amplifier 1026 do not respond to the triangular wave PWM carrier signal supplied from the PWM modulator 1024 to the first input terminal In1. In such an instance, a significant bias voltage is supplied to the amplifying transistors of the first VCM driver output amplifier 1025 and the second VCM driver output amplifier 1026 in response to the low-level PWM operation enable signal PWMENA. Hence, the amplifying transistors can perform a class AB amplifier operation to reduce the distortion in a signal amplified by them.

Linear amplifier output signals having opposite phases are generated from the first VCM driver output amplifier 1025 and the second VCM driver output amplifier 1026. The linear amplifier output signals having opposite phases drive both terminals of the voice coil motor (VCM). The linear drive mode based on analog control in which an amplified amplitude varies is suitable, for instance, for a tracking operation and other operations in which the magnetic head is driven to move to a small extent.

The pre-driver 1021, feedback capacitor 1022, feedback resistor 1023, and feedback amplifier 1027 included in the driver output section 102 depicted in FIG. 1 function as a negative feedback loop that enhances the amplification accuracy of the driver output section 102. The negative feedback loop also functions when the first VCM driver output amplifier 1025 and the second VCM driver output amplifier 1026 operate in either the pulse drive mode or the linear drive mode. In other words, the feedback amplifier 1027 senses an inter-terminal amplified voltage between the output terminal of the first VCM driver output amplifier 1025 and the output terminal of the second VCM driver output amplifier 1026, and supplies the sensed inter-terminal amplified voltage to the inverting input terminal− of the pre-driver 1021. As the analog drive voltage command signal ADRV from the digital-to-analog converter 101 is supplied to the non-inverting input terminal+ of the pre-driver 1021, the negative feedback loop functions in such a manner that the voltage information about the inverting input terminal− of the pre-driver 1021 agrees with the voltage information about the non-inverting input terminal+ of the pre-driver 1021. Consequently, the analog drive voltage command signal ADRV at the non-inverting input terminal+ of the pre-driver agrees with the amplified voltage between the output terminals of the first and second VCM driver output amplifiers 1025, 1026, which is delivered to the inverting input terminal− of the pre-driver 1021. The feedback capacitor 1022 and the feedback resistor 1023 not only function as a phase compensation circuit for improving the stability of the negative feedback loop, but also function as a filter for smoothing a pulse waveform signal output from the feedback amplifier 1027 during a PWM operation.

### <<Drive Current Sensing Amplifier>>

In the semiconductor integrated circuit IC according to the first embodiment, which is depicted in FIG. 1, the inter-terminal voltage of the current sensing resistor Rs is supplied to a differential input terminal of the drive current sensing amplifier 103 through two current sensing terminals RSINP, RSINN. One current sensing terminal RSINP is coupled to a non-inverting input terminal+ of a differential amplifier 1031 in the drive current sensing amplifier 103 through the resistor 1032. A reference voltage V_{REF} is supplied to this non-inverting input terminal+ through the resistor 1033. The other current sensing terminal RSINN is coupled to an inverting input terminal− of the differential amplifier 1031 in the drive current sensing amplifier 103 through the resistor 1034. This inverting input terminal− is coupled to the output terminal of the differential amplifier 1031 through the resistor 1035.

Hence, the drive current sensing amplifier 103 senses the current value of the coil drive current Ivcm that flows in the current sensing resistor Rs coupled in series to the voice coil motor (VCM). The drive current analog sensing signal AIVCM generated from the output terminal of the drive current sensing amplifier 103 is converted to the drive current digital sensing signal DIVCM by the analog-to-digital converter 104, the decimation filter 105, and the offset calibration section 106. In other words, the drive current information about the voice coil motor (VCM) is used as the feedback information about the drive current digital sensing signal DIVCM, which is to be delivered to the digital difference generation/phase compensation control section 100.

An amplifier gain of the drive current sensing amplifier 103 can be set by the digital control signal VCMFS, which is supplied from the external microcomputer or other controller through the serial input/output interface 107.

### <<Analog-to-Digital Converter>>

In the semiconductor integrated circuit IC according to the first embodiment, which is depicted in FIG. 1, an analog amplifier output signal from the output terminal of the drive current sensing amplifier 103 is converted to a digital current sensing signal by the analog-to-digital converter 104 and supplied to the input terminal of the decimation filter 105.

An oversampling ΣΔ analog-to-digital converter, which has a small circuit scale and is capable of reducing folding noise and quantization noise, is used as the analog-to-digital converter 104. This oversampling ΣΔ analog-to-digital converter can be formed of an analog subtractor, an analog integrator, a comparator, a delay circuit, and a 1-bit local digital-to-analog converter. Therefore, the circuit scale can be reduced. Further, the oversampling ΣΔ analog-to-digital converter also performs difference generation, difference integration, and integrated value feedback processing. Therefore, a high signal-to-noise ratio can be achieved due to the noise shaping effect.

### <<Decimation Filter>>

The decimation filter 105 in the semiconductor integrated circuit IC according to the first embodiment, which is depicted in FIG. 1, performs a decimation process so that a sampling rate raised by the above-mentioned oversampling ΣΔ analog-to-digital converter 104 is lowered to an appropriate sampling rate. The decimation filter 105 also functions as a low-pass filter that suppresses the quantization noise in a high-frequency region, which is increased by an amount by which the quantization noise in a low-frequency region is reduced due to the noise shaping effect produced by the oversampling ΣΔ analog-to-digital converter 104. Hence, although the decimation filter 105 is formed of a digital filter, it includes a low-pass filter and a decimation circuit.

### <<Offset Calibration Section>>

Before feedback control is exercised by the digital difference generation/phase compensation control section 100, the offset calibration section 106 in the semiconductor integrated circuit IC according to the first embodiment, which is depicted in FIG. 1, performs a calibration operation to reduce the error in the drive current sensing amplifier 103, the analog-to-digital converter 104, and the decimation filter 105. To permit such an operation to be performed, control is exercised so that the current value of the coil drive current Ivcm of the voice coil motor (VCM) is zero, and the inter-terminal voltage of the current sensing resistor Rs is supplied to the differential input terminal of the drive current sensing amplifier 103 through the two current sensing terminals RSINP, RSINN. The whole error information obtained in the resulting state, including the information about the error in the drive current sensing amplifier 103, the error in the analog-to-digital converter 104, and the error in the decimation filter 105, is stored in a calibration register 1061 in the offset calibration section 106. In response to the calibration enable signal CALENA, the above-mentioned whole error information is stored from the decimation filter 105 into the calibration register 1061 in the offset calibration section 106 and kept in storage.

In a subsequent drive current sensing operation, the error information stored in the calibration register 1061 in the offset calibration section 106 is supplied to a digital subtractor 1062. The digital subtractor 1062 then subtracts the error information from a whole set of normally sensed information. The whole set of normally sensed information includes a normally output signal of the drive current sensing amplifier 103, a normally converted signal of the analog-to-digital converter 104, and a normally output signal of the decimation filter 105. A subtractor output signal of the digital subtractor 1062 in the offset calibration section 106 is digitally amplified by the digital amplifier 1063 formed of a digital multiplier so that the drive current digital sensing signal DIVCM is generated from the output of the digital amplifier 1063. This makes it possible to sufficiently reduce an error component included in the drive current digital sensing signal DIVCM generated from the output of the digital amplifier 1063 in the offset calibration section 106.

### <<Advantageous Effect of First Embodiment>>

The semiconductor integrated circuit IC according to the first embodiment, which has been described with reference to FIGS. 1 to 3, is configured so that the internal digital control signal VCMFS_i at high level “1” automatically sets the drive current sensing amplifier 103 in the high-gain state in response to a digital drive current command value VCMCRNT that is between the positive and negative predetermined threshold voltages of the gain threshold voltage GAIN_TH. Meanwhile, in response to a digital drive current command value VCMCRNT that is greater than the positive predetermined threshold voltage of the gain threshold voltage GAIN_TH or smaller than the negative predetermined threshold voltage of the gain threshold voltage GAIN_TH, the internal digital control signal VCMFS_i at low level “0” automatically sets the drive current sensing amplifier 103 in the low-gain state.

Consequently, according to the first embodiment, which has been described with reference to FIGS. 1 to 3, the control software of the external microcomputer or other controller does not need to exercise control so as to change the digital control signal VCMFS to high level “1” or to low level “0” as described with reference to FIGS. 8 and 9. As a result, the first embodiment, which has been described with reference to FIGS. 1 to 3, provides a remarkable advantageous effect of reducing the burden on the design engineer of a hard disk drive or the like.

<<Problem with First Embodiment>>

As describe above, the first embodiment described with reference to FIGS. 1 to 3 provides a remarkable advantageous effect of reducing the burden on the design engineer of a hard disk drive or the like because it automatically sets the gain of the drive current sensing amplifier 103 in response to the digital value of the digital drive current command value VCMCRNT.

However, when the inventors of the present invention conducted more detailed studies on the semiconductor integrated circuit IC according to the first embodiment, which has been described with reference to FIGS. 1 to 3, the inventors found that the first embodiment has the following problem.

In the semiconductor integrated circuit IC according to the first embodiment, which has been described with reference to FIGS. 1 to 3, spike noise occurs in the coil drive current Ivcm and in the current difference information IERR when the internal digital control signal VCMFS_i switches between high level “1” and low level “0” due to changes in the digital drive current command value VCMCRNT.

As a result, the generated spike noise degrades the magnetic head's responsiveness to control when a seek operation or a tracking operation is performed by a hard disk drive (HDD) having the semiconductor integrated circuit IC according to the first embodiment, which has been described with reference to FIGS. 1 to 3.

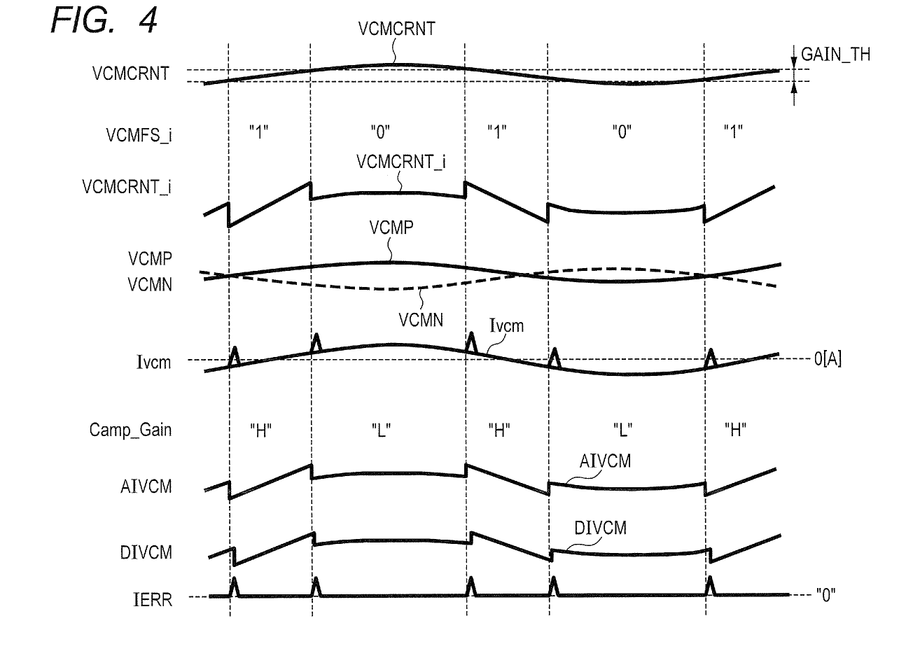

FIG. 4 is a diagram illustrating a mechanism in which spike noise occurs in the coil drive current Ivcm and in the current difference information IERR when the internal digital control signal VCMFS_i switches between high level “1” and low level “0” in the semiconductor integrated circuit IC according to the first embodiment, which has been described with reference to FIGS. 1 to 3.

FIG. 4 additionally depicts the drive current digital sensing signal DIVCM and the digital difference drive current information IERR, which are not depicted in FIG. 3. The drive current digital sensing signal DIVCM is generated from the digital amplifier 1063 of the offset calibration section 106. The digital difference drive current information IERR is generated from the digital subtractor 1002 of the digital difference generation/phase compensation control section 100.

As is obvious from FIG. 4, the response of the drive current digital sensing signal DIVCM, which is generated from the digital amplifier 1063 of the offset calibration section 106, is delayed from the response of the internal digital drive current command value VCMCRNT_i. It is conceivable that this delay is caused, for instance, by a signal delay in the oversampling EA analog-to-digital converter used as the analog-to-digital converter 104 and by a signal delay in the low-pass filter and decimation circuit of the decimation filter 105.

As described above, the response of the drive current digital sensing signal DIVCM is delayed from the response of the internal digital drive current command value VCMCRNT_i. Therefore, the spike noise occurs in the digital difference drive current information IERR at a timing at which the internal digital control signal VCMFS_i switches between high level “1” and low level “0”. More specifically, the value of the drive current digital sensing signal DIVCM becomes smaller than the value of the internal digital drive current command value VCMCRNT_i immediately before each timing of switching. Thus, the digital difference drive current information IERR corresponding to the difference between these two values drastically becomes greater than the target value of “0”. Further, the value of the drive current digital sensing signal DIVCM becomes greater than the value of the internal digital drive current command value VCMCRNT_i immediately after each timing of switching. Thus, the digital difference drive current information IERR corresponding to the difference between these two values drastically decreases to reach the target value of “0”. Eventually, the spike noise also occurs in the drive current Ivcm of the voice coil motor (VCM) in response to the spike noise in the digital difference drive current information IERR.

### Second Embodiment

A second embodiment of the present invention solves the problem with the semiconductor integrated circuit IC according to the first embodiment, which has been described earlier. More specifically, the second embodiment solves the problem in which the spike noise occurs in the coil drive current Ivcm and in the current difference information IERR when the internal digital control signal VCMFS_i switches between high level “1” and low level “0” due to changes in the digital drive current command value VCMCRNT.

### <<Configuration of Semiconductor Integrated Circuit According to Second Embodiment>>

FIG. 5 is a diagram illustrating the configuration of the semiconductor integrated circuit according to the second embodiment, which is the so-called voice coil driver IC for driving the voice coil motor (VCM) that moves the magnetic head of a hard disk drive (HDD).

The difference between the semiconductor integrated circuit IC according to the second embodiment, which is depicted in FIG. 5, and the semiconductor integrated circuit IC according to the first embodiment, which is depicted in FIG. 1, will now be described.

### <<Selector>>

First of all, the digital difference generation/phase compensation control section 100 depicted in FIG. 5 is configured so that a selector 1007 is added between the output terminal of the digital subtractor 1002 and one input terminal each of the two digital multipliers 1003, 1004. More specifically, a first input terminal of the selector 1007 is coupled to the output terminal of the digital subtractor 1002. A value of “0000” in hexadecimal or “0” in decimal is supplied to a second input terminal of the selector 1007 as the target value of “0” for the digital difference drive current information IERR. The output terminal of the selector 1007 is coupled to one input terminal each of the two digital multipliers 1003, 1004. Further, at each timing at which the internal digital control signal VCMFS_i switches between high level “1” and low level “0”, a mask control signal MASK having high level “1” is supplied to a selection control terminal of the selector 1007 from a mask control signal generation section 109, which is described below. As a result, at each timing of switching, the selector 1007 selects a value of “0000” in hexadecimal or “0” in decimal at the second input terminal and outputs the selected value to its output terminal. At the other timings, the selector 1007 selects the current difference information IERR at the output terminal of the digital subtractor 1002 and outputs the selected current difference information IERR to its output terminal.

### <<Configuration of Mask Control Signal Generation Section>>

Next, the mask control signal generation section 109, which generates the above-mentioned mask control signal MASK, is added to the semiconductor integrated circuit IC according to the second embodiment, which is depicted in FIG. 5.

As depicted in FIG. 5, the mask control signal generation section 109 includes a delay flip-flop 1091, an exclusive-OR circuit 1092, a selector 1093, a register 1094, an adder 1095, and a comparator 1096.

The internal digital control signal VCMFS_i generated from the digital computation section 108 is supplied to the input terminal of the delay flip-flop 1091 and to a first input terminal of the exclusive-OR circuit 1092. A delay output signal of the delay flip-flop 1091 is supplied to a second input terminal of the exclusive-OR circuit 1092. An exclusive-OR output signal of the exclusive-OR circuit 1092 is supplied to a selection control input terminal of the selector 1093.

The selector 1093, the register 1094, and the adder 1095 form a counter. An initial value of “0” for a counting operation of the counter is supplied to a first input terminal of the selector 1093. A count increment value at the output terminal of the adder 1095 is supplied to a second input terminal of the selector 1093. The output signal of the selector 1093 is supplied to the input terminal of the register 1094. A count value CNT at the output terminal of the register 1094 is supplied to a first input terminal of the adder 1095. An addition value of “1”, which is an increment value, is supplied to a second input terminal of the adder 1095. Referring to FIG. 5, a high-speed clock is supplied to the adder 1095. The adder 1095 performs an addition operation in response to the high-speed clock.

The count value CNT at the output terminal of the register 1094 and a reference value REF are respectively supplied to first and second input terminals of the comparator 1096. The output terminal of the comparator 1096 generates the mask control signal MASK, which is to be supplied to the selection control terminal of the selector 1007 in the digital difference generation/phase compensation control section 100.

The digital computation section 108 and the other elements of the semiconductor integrated circuit IC according to the second embodiment, which is depicted in FIG. 5, are identical with those of the semiconductor integrated circuit IC according to the first embodiment, which is depicted in FIG. 1.

### <<Operation of Mask Control Signal Generation Section>>

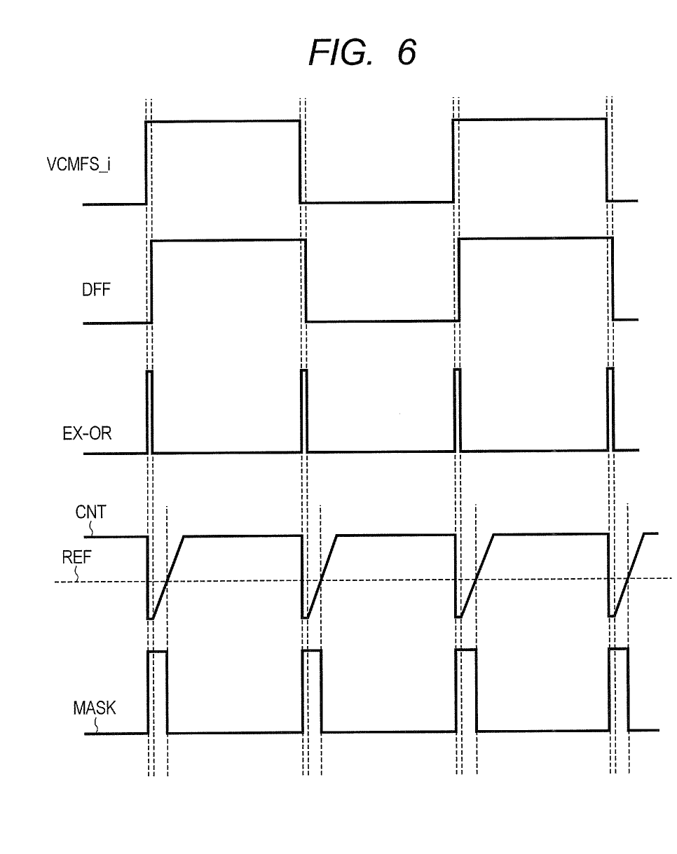

FIG. 6 is a diagram illustrating an operation of the mask control signal generation section 109 included in the semiconductor integrated circuit IC according to the second embodiment, which is depicted in FIG. 5.

A first portion of FIG. 6 depicts the waveform of the internal digital control signal VCMFS_i, which is generated from the digital computation section 108 and supplied to the input terminal of the delay flip-flop 1091 and to the first input terminal of the exclusive-OR circuit 1092.

A second portion of FIG. 6 depicts the waveform of the delay output signal DFF of the delay flip-flop 1091, which is supplied to the second input terminal of the exclusive-OR circuit 1092.

A third portion of FIG. 6 depicts the waveform of the exclusive-OR output signal EX-OR of the exclusive-OR circuit 1092.

The exclusive-OR output signal EX-OR is at high level “1” at each timing at which the internal digital control signal VCMFS_i switches between high level “1” and low level “0”, and at low level “0” at the other timings. Therefore, at each timing at which the internal digital control signal VCMFS_i switches between high level “1” and low level “0”, the initial value of “0” for a count operation of the counter, which is supplied to the first input terminal of the selector 1093, is stored in the register 1094 of the counter. At the other timings, on the other hand, the count value CNT at the output terminal of the register 1094, which is generated when the adder 1095 performs an incremental addition operation in response to the high-speed clock, is stored in the register 1094 of the counter.

Hence, as depicted in a fourth portion of FIG. 6, the count value CNT of the register 1094 is set to the initial value of “0” in response to the exclusive-OR output signal EX-OR at high level “1”, and then incremented to its maximum value while the exclusive-OR output signal EX-OR is at low level “0”. As a result, the count value CNT of the register 1094 crosses the reference value REF between its initial value of “0” and its maximum value.

Consequently, as depicted in a fifth portion of FIG. 6, the mask control signal MASK is at high level “1” during a period during which the count value CNT of the register 1094 is smaller than the reference value REF, and at low level “0” during the other periods.

As described above, the mask control signal generation section 109 generates the mask control signal MASK having high level “1” at each timing at which the internal digital control signal VCMFS_i switches between high level “1” and low level “0”. Further, the high-level period of the mask control signal MASK is set to be substantially equal to the noise pulse width of the spike noise in the coil drive current Ivcm and in the current difference information IERR, which is depicted in FIG. 4.

### <<Reduction of Spike Noise>>

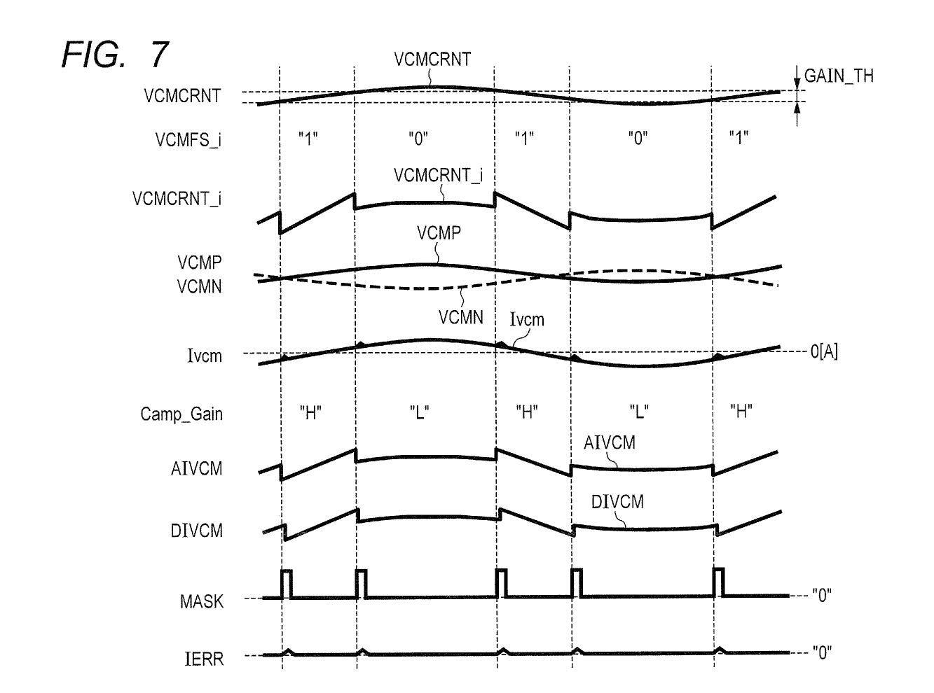

FIG. 7 is a diagram illustrating how the spike noise in the coil drive current Ivcm and current difference information IERR is reduced in response to the mask control signal MASK generated by the mask control signal generation section 109 of the semiconductor integrated circuit IC according to the second embodiment, which is depicted in FIG. 5.

The difference between the operation waveform of the semiconductor integrated circuit IC according to the second embodiment, which is depicted in FIG. 7, and the operation waveform of the semiconductor integrated circuit IC according to the first embodiment, which is depicted in FIG. 4, will now be described.

Briefly, the mask control signal MASK having high level “1” and a predetermined high-level period is added to the operation waveform of FIG. 7 at each timing at which the internal digital control signal VCMFS_i switches between high level “1” and low level “0”.

Hence, the selector 1007 in the digital difference generation/phase compensation control section 100 is controlled in response to the mask control signal MASK, which changes to high level “1” at each timing at which the internal digital control signal VCMFS_i switches between high level “1” and low level “0”.

In other words, as depicted in the lowest portion of FIG. 7, the selector 1007 in the digital difference generation/phase compensation control section 100 according to the second embodiment, which is depicted in FIG. 5, selects a value of “0000” in hexadecimal or “0” in decimal, which is supplied to the second input terminal as the target value of “0” for the digital difference drive current information IERR in response to the mask control signal MASK at high level “1”, and outputs the selected value to its output terminal.

Consequently, the semiconductor integrated circuit IC according to the second embodiment, which is depicted in FIG. 5, reduces the spike noise in the digital difference drive current information IERR at each timing at which the internal digital control signal VCMFS_i switches between high level “1” and low level “0”. As a result, the semiconductor integrated circuit IC according to the second embodiment, which is depicted in FIG. 5, reduces the spike noise in the coil drive current Ivcm at each timing at which the internal digital control signal VCMFS_i switches between high level “1” and low level “0”.

### <<Advantageous Effect of Second Embodiment>>

The semiconductor integrated circuit IC according to the second embodiment, which has been described with reference to FIGS. 5 to 7, is configured so that the selector 1007 selects a value of “0000” in hexadecimal or “0” in decimal, which is supplied to the second input terminal as the target value of “0” for the digital difference drive current information IERR in response to the mask control signal MASK at high level “1”, and outputs the selected value to its output terminal. This makes it possible to reduce the spike noise in the coil drive current Ivcm at each timing at which the internal digital control signal VCMFS_i switches between high level “1” and low level “0”.

While the embodiments of the present invention have been described in detail, the present invention is not limited to the specific embodiments described above. It is to be understood that many variations and modifications of the present invention may be made without departing from the spirit and scope of the present invention.

For example, the motor drive control device according to an embodiment of the present invention is not limited to a voice coil motor driver that drives a voice coil motor (VCM) used in a hard disk drive (HDD). The present invention is also applicable, for instance, to a motor driver that drives an arm of an industrial robot for ultra-precision machining.

What is claimed is:

1. A motor drive control device comprising:
a digital control section;
a digital-to-analog converter having an input terminal;
a driver output section having an input terminal and an output terminal;
a drive current sensing amplifier having a gain;
an analog-to-digital converter;
an interface; and
a computation section,
wherein the output terminal of the driver output section can be coupled to a series coupling between a motor and a sensing resistor,
wherein the drive current sensing amplifier generates a drive current analog sensing signal in response to a drive current flowing in the sensing resistor,
wherein the analog-to-digital converter generates a drive current digital sensing signal in response to the drive current analog sensing signal generated by the drive current sensing amplifier,
wherein the digital control section generates a digital drive voltage command signal, which is to be supplied to the input terminal of the digital-to-analog converter, in response to a digital drive current command value supplied from the interface and in response to the drive current digital sensing signal generated from the analog-to-digital converter,
wherein the digital-to-analog converter generates an analog drive voltage command signal, which is to be supplied to the input terminal of the driver output section, in response to the digital drive voltage command signal supplied from the digital control section,
wherein the driver output section generates a drive output signal, which drives the series coupling between the motor and the sensing resistor, in response to the analog drive voltage command signal generated from the digital-to-analog converter,
wherein, in response to the digital drive current command value that is between a positive predetermined threshold voltage and a negative predetermined threshold voltage, the computation section generates an internal control signal to be in a first state, and exercises control so as to place the gain of the drive current sensing amplifier in a first state, and
wherein, in response to the digital drive current command value that is not between the positive predetermined threshold voltage and the negative predetermined threshold voltage, the computation section generates the internal control signal to be in a second state, which is different from the first state, and exercises control so as to place the gain of the drive current sensing amplifier in a second state, which is lower than the first state.

2. The motor drive control device according to claim 1, the computation section comprising:
a variable digital amplifier; and
a digital comparator,
wherein the digital comparator operates as a window comparator in accordance with the digital drive current command value, the positive predetermined threshold voltage, and the negative predetermined threshold voltage,
wherein, when the digital drive current command value is between the positive predetermined threshold voltage and the negative predetermined threshold voltage, the output signal of the digital comparator controls the digital gain of the variable digital amplifier at a predetermined value,
wherein, in response to an internal digital drive current command value generated from the output terminal of the variable digital amplifier whose digital gain is controlled at the predetermined value and in response to the drive current digital sensing signal generated from the analog-to-digital converter, the digital control section generates the digital drive voltage command signal,
wherein, when the digital drive current command value is not between the positive predetermined threshold voltage and the negative predetermined threshold voltage, the output signal of the digital comparator controls the digital gain of the variable digital amplifier at a value smaller than the predetermined value, and
wherein, in response to the internal digital drive current command value generated from the output terminal of the variable digital amplifier whose digital gain is controlled at the value smaller than the predetermined value and in response to the drive current digital sensing signal generated from the analog-to-digital converter, the digital control section generates the digital drive voltage command signal.

3. The motor drive control device according to claim 2, the digital control section comprising:
a digital subtractor; and
a selector,
wherein the motor drive control device further includes a mask control signal generation section that generates a mask control signal having a predetermined mask level at each timing at which the internal control signal generated from the computation section switches between the first state and the second state,
wherein the digital subtractor generates digital difference drive current information by subtracting the drive current digital sensing signal generated from the analog-to-digital converter from the internal digital drive current command value generated from the computation section,
wherein the digital difference drive current information generated from the digital subtractor is supplied to a first input terminal of the selector, a target value for the digital difference drive current information is supplied to a second input terminal of the selector, and the digital drive voltage command signal is generated from the output terminal of the selector,
wherein, when the mask control signal having the predetermined mask level, which is generated from the mask control signal generation section, is supplied to a selection control terminal of the selector, the target value supplied to the second input terminal of the selector is selected and output from the output terminal of the selector as the digital drive voltage command signal, and
wherein, when the mask control signal having the predetermined mask level, which is generated from the mask control signal generation section, is not supplied to the selection control terminal of the selector, the digital difference drive current information supplied to the first input terminal of the selector is selected and output from the output terminal of the selector as the digital drive voltage command signal.

4. The motor drive control device according to claim 2, the driver output section comprising:
a pre-driver;
a first driver output amplifier; and
a second driver output amplifier,
wherein the analog drive voltage command signal generated from the digital-to-analog converter is supplied to the input terminal of the pre-driver,
wherein the output terminal of the pre-driver is coupled to the input terminal of the first driver output amplifier and to the input terminal of the second driver output amplifier, and the output terminal of the first driver output amplifier and the output terminal of the second driver output amplifier can be respectively coupled to one end and the other end of the series coupling between the motor and the sensing resistor,
wherein, in a pulse drive operation mode, the first driver output amplifier and the second driver output amplifier generate a drive pulse having a pulse width proportional to the voltage level of the output terminal of the pre-driver, and
wherein, in a linear drive mode, which is different from the pulse drive operation mode, the first driver output amplifier and the second driver output amplifier generate an amplifier output signal proportional to the voltage level of the output terminal of the pre-driver.

5. The motor drive control device according to claim 4,
wherein, in the pulse drive operation mode, a predetermined bias voltage is supplied to a transistor of the first driver output amplifier and to a transistor of the second driver output amplifier so that the first driver output amplifier and the second driver output amplifier perform a class D amplifier operation, and
wherein, in the linear drive mode, a bias voltage higher than the predetermined bias voltage is supplied to the transistor of the first driver output amplifier and to the transistor of the second driver output amplifier so that the first driver output amplifier and the second driver output amplifier perform a class AB amplifier operation.

6. The motor drive control device according to claim 5, wherein the digital-to-analog converter is a ΣΔ digital-to-analog converter.

7. The motor drive control device according to claim 6, wherein the analog-to-digital converter is an oversampling ΣΔ analog-to-digital converter.

8. The motor drive control device according to claim 7, further comprising:
a decimation filter that is coupled between the output terminal of the oversampling ΣΔ analog-to-digital converter and the digital subtractor of the digital control section,
wherein the decimation filter performs a decimation process to decimate a converted output signal of the oversampling ΣΔ analog-to-digital converter and a low-pass filter process to suppress quantization noise in a high-frequency region of the oversampling ΣΔ analog-to-digital converter.

9. The motor drive control device according to claim 8, further comprising:
an offset calibration section that is coupled between the output terminal of the decimation filter and the digital subtractor of the digital control section,
wherein the offset calibration section includes a calibration register and an offset digital subtractor,
wherein, while the drive current of the sensing resistor is substantially set to zero, error information about the drive current sensing amplifier, the analog-to-digital converter, and the decimation filter is stored in the calibration register, and
wherein, during a normal operation, the offset digital subtractor generates the drive current sensing signal, which is the digital sensing signal to be fed back to the digital subtractor of the digital control section, by subtracting the error information stored in the calibration register from the output signal of the decimation filter.

10. The motor drive control device according to claim 9, wherein the motor is a voice coil motor that moves a magnetic head of a hard disk drive.

11. The motor drive control device according to claim 10, wherein the digital control section, the digital-to-analog converter, the driver output section, the drive current sensing amplifier, the analog-to-digital converter, the decimation filter, the offset calibration section, and the computation section are integrated into a semiconductor chip of a semiconductor integrated circuit.

12. The motor drive control device according to claim 3, the driver output section comprising:
a pre-driver;
a first driver output amplifier; and
a second driver output amplifier,
wherein the analog drive voltage command signal generated from the digital-to-analog converter is supplied to the input terminal of the pre-driver,
wherein the output terminal of the pre-driver is coupled to the input terminal of the first driver output amplifier and to the input terminal of the second driver output amplifier, and the output terminal of the first driver output amplifier and the output terminal of the second driver output amplifier can be respectively coupled to one end and the other end of the series coupling between the motor and the sensing resistor,
wherein, in a pulse drive operation mode, the first driver output amplifier and the second driver output amplifier generate a drive pulse having a pulse width proportional to the voltage level of the output terminal of the pre-driver, and
wherein, in a linear drive mode, which is different from the pulse drive operation mode, the first driver output amplifier and the second driver output amplifier generate an amplifier output signal proportional to the voltage level of the output terminal of the pre-driver.

13. The motor drive control device according to claim 12,
wherein, in the pulse drive operation mode, a predetermined bias voltage is supplied to a transistor of the first driver output amplifier and to a transistor of the second driver output amplifier so that the first driver output amplifier and the second driver output amplifier perform a class D amplifier operation, and
wherein, in the linear drive mode, a bias voltage higher than the predetermined bias voltage is supplied to the transistor of the first driver output amplifier and to the transistor of the second driver output amplifier so that the first driver output amplifier and the second driver output amplifier perform a class AB amplifier operation.

14. The motor drive control device according to claim 13, wherein the digital-to-analog converter is a ΣΔ digital-to-analog converter.

15. The motor drive control device according to claim 14, wherein the analog-to-digital converter is an oversampling ΣΔ analog-to-digital converter.

16. The motor drive control device according to claim 15, further comprising:
a decimation filter that is coupled between the output terminal of the oversampling ΣΔ analog-to-digital converter and the digital subtractor of the digital control section,
wherein the decimation filter performs a decimation process to decimate a converted output signal of the oversampling ΣΔ analog-to-digital converter and a low-pass filter process to suppress quantization noise in a high-frequency region of the oversampling ΣΔ analog-to-digital converter.

17. The motor drive control device according to claim 16, further comprising:
an offset calibration section that is coupled between the output terminal of the decimation filter and the digital subtractor of the digital control section,
wherein the offset calibration section includes a calibration register and an offset digital subtractor,
wherein, while the drive current of the sensing resistor is substantially set to zero, error information about the drive current sensing amplifier, the analog-to-digital converter, and the decimation filter is stored in the calibration register, and
wherein, during a normal operation, the offset digital subtractor generates the drive current sensing signal, which is the digital sensing signal to be fed back to the digital subtractor of the digital control section, by subtracting the error information stored in the calibration register from the output signal of the decimation filter.

18. The motor drive control device according to claim 17, wherein the motor is a voice coil motor that moves a magnetic head of a hard disk drive.

19. The motor drive control device according to claim 18, wherein the digital control section, the digital-to-analog converter, the driver output section, the drive current sensing amplifier, the analog-to-digital converter, the decimation filter, the offset calibration section, the computation section, and the mask control signal generation section are integrated into a semiconductor chip of a semiconductor integrated circuit.

20. An operating method for a motor drive control device having a digital control section, a digital-to-analog converter, a driver output section, a drive current sensing amplifier, an analog-to-digital converter, an interface, and a computation section, the operating method comprising the steps of:
allowing an output terminal of the driver output section to be coupled to a series coupling between a motor and a sensing resistor;
causing the drive current sensing amplifier to generate a drive current analog sensing signal in response to a drive current flowing in the sensing resistor;
causing the analog-to-digital converter to generate a drive current digital sensing signal in response to the drive current analog sensing signal generated by the drive current sensing amplifier;
causing the digital control section to generate a digital drive voltage command signal, which is to be supplied to the input terminal of the digital-to-analog converter, in response to a digital drive current command value supplied from the interface and in response to the drive current digital sensing signal generated from the analog-to-digital converter;
causing the digital-to-analog converter to generate an analog drive voltage command signal, which is to be supplied to the input terminal of the driver output section, in response to the digital drive voltage command signal supplied from the digital control section;
causing the driver output section to generate a drive output signal, which drives the series coupling between the motor and the sensing resistor, in response to the analog drive voltage command signal generated from the digital-to-analog converter;
in response to the digital drive current command value that is between a positive predetermined threshold voltage and a negative predetermined threshold voltage, causing the computation section to generate an internal control signal that is in a first state, and exercise control so as to place the gain of the drive current sensing amplifier in a first state; and
in response to the digital drive current command value that is not between the positive predetermined threshold voltage and the negative predetermined threshold voltage, causing the computation section to generate the internal control signal that is in a second state, which is different from the first state, and exercise control so as to place the gain of the drive current sensing amplifier in a second state, which is lower than the first state.
